(19) United States
(12) Patent Application Publication
(10) Pub. No.: US 2026/0155757 A1
(43) Pub. Date: Jun. 4, 2026

(54) AC-DC CONVERTER

(71) Applicant: Murata Manufacturing Co., Ltd., Nagaokakyo-shi (JP)

(72) Inventors: Yuki ISHIKURA, Nagaokakyo-shi (JP); Chinmay BHAGAT, Nagaokakyo-shi (JP); Takuya MURASATO, Nagaokakyo-shi (JP)

(73) Assignee: Murata Manufacturing Co., Ltd., Nagaokakyo-shi (JP)

(21) Appl. No.: 19/457,269

(22) Filed: Jan. 23, 2026

Related U.S. Application Data
(63) Continuation of application No. PCT/JP2024/026388, filed on Jul. 24, 2024.

(30) Foreign Application Priority Data
Jul. 26, 2023 (JP) 2023-121757
Mar. 11, 2024 (WO) PCT/JP2024/009446

(51) Int. Cl. H02M 7/219

(52) U.S. Cl. CPC H02M 7/219

(57) ABSTRACT

An AC-DC converter includes a power conversion circuit, an isolation transformer assembly, and first and second rectifier circuits. The power conversion circuit generates a primary current of a predetermined frequency from input power supplied from a input. The isolation transformer includes first and second primary coils connected in series with the power conversion circuit, a first secondary coil coupled with the first primary coil, and a second secondary coil coupled with the second primary coil. The isolation transformer outputs first and second secondary currents based on the primary current. First and second rectifier circuits is connected to the first secondary coil are connected in parallel and respectively rectify s secondary currents from the secondary coils. Each rectifier circuit includes a switch, and an inductor The isolation transformer assembly further includes first and second isolation transformers arranged such that magnetic coupling between them is suppressed.

### CROSS-REFERENCE TO RELATED APPLICATIONS

This application is a continuation application of International Application No. PCT/JP2024/026388, filed on Jul. 24, 2024, which claims priority to Japanese Patent Application No. 2023-121757, filed on Jul. 26, 2023, and claims priority to International Application No. PCT/JP2024/009446, filed on Mar. 11, 2024. The entire contents of each of the above-identified applications are incorporated herein by reference.

### TECHNICAL FIELD

The present discloses relates to an AC-DC converter.

### BACKGROUND ART

Patent Document 1 discloses a charging device. This charging device includes a non-isolated converter having a power factor correction function and an isolated converter.

The input terminal of this non-isolated converter having a power factor correction function is connected to an AC power source. The output terminal of the non-isolated converter having a power factor correction function is connected to the isolated converter. The output side of the isolated converter is connected to a battery.

The non-isolated converter generates a predetermined output voltage while correcting the power factor of an input current. The isolated converter, which includes an isolation transformer, receives DC power from the non-isolated converter and performs voltage conversion by using the transformer.

A rectifier circuit is connected to the secondary winding of the transformer. The rectifier circuit includes multiple diodes and rectifies the voltage output from the secondary winding of the transformer.

### CITATION LIST

### Patent Document

Patent Document 1: Japanese Unexamined Patent Application Publication No. 2014-53992

### SUMMARY

An AC-DC converter of the disclosure includes a power conversion circuit, an isolation transformer, first and second rectifier circuits, and a smoothing capacitor. The power conversion circuit is connected to a three-phase AC power source and outputs a primary current. The isolation transformer includes first and second primary coils and first and second secondary coils and outputs first and second secondary currents by using the primary current as input. The first and second primary coils are connected in series with an output side of the power conversion circuit. The first secondary coil is coupled with the first primary coil. The second secondary coil is coupled with the second primary coil. The first rectifier circuit is connected to the first secondary coil and rectifies the first secondary current. The second rectifier circuit is connected to the second secondary coil and rectifies the second secondary current. The smoothing capacitor is connected to an output terminal of the first rectifier circuit and an output terminal of the second rectifier circuit. The isolation transformer includes first and second isolation transformers. Magnetic coupling between the first and second isolation transformers is suppressed. The first and second primary coils are connected in series with each other. The first isolation transformer includes the first primary coil and the first secondary coil. The second isolation transformer includes the second primary coil and the first secondary coil. The first and second rectifier circuits are connected in parallel with each other. The first rectifier circuit includes a first switching device, and a first inductor is connected to the first switching device. The second rectifier circuit includes a second switching device, and a second inductor is connected to the second switching device.

### BRIEF DESCRIPTION OF DRAWINGS

FIG. 1 is a circuit diagram of an AC-DC converter according to a first embodiment.

FIG. 2 is a circuit diagram of an AC-DC converter according to a second embodiment.

FIG. 3 is a circuit diagram of rectifier circuits connected to secondary coils of isolation transformers in the AC-DC converter of the second embodiment.

FIG. 4(A) and FIG. 4(B) illustrate the configuration of a circuit module that implements a circuit from the isolation transformers to the output terminal of the AC-DC converter of the second embodiment.

FIG. 5 illustrates an example of wiring patterns for the rectifier circuits.

FIG. 6 is a circuit diagram of an AC-DC converter according to a third embodiment.

FIG. 7 is a circuit diagram of rectifier circuits of an AC-DC converter according to a fourth embodiment.

FIG. 8 is a circuit diagram of rectifier circuits of an AC-DC converter according to a fifth embodiment.

FIG. 9 is a circuit diagram of an AC-DC converter according to a sixth embodiment.

FIG. 10 is a circuit diagram of an AC-DC converter according to a seventh embodiment.

FIG. 11 is a circuit diagram of an AC-DC converter according to an eighth embodiment.

FIG. 12(A), FIG. 12(B), and FIG. 12(C) are sectional views illustrating the schematic configurations of DC inductors.

FIG. 13(A) is a waveform diagram illustrating an example of the waveform of an inductor current observed when a DC inductor in the application of the invention is used; and FIG. 13(B) is a waveform diagram illustrating an example of the waveform of an inductor current in a comparative example.

### DESCRIPTION OF EMBODIMENTS

In the configuration of the related art, such as that in Patent Document 1, the inventors have realized that, if an input power source using a three-phase current is employed, the output current may be elevated, which may increase the loss in rectifier devices of the rectifier circuit connected to the secondary coil of the transformer of the isolated converter.

Accordingly, the present disclosures is directed to implementing an AC-DC converter that can reduce the loss even when an output current is increased.

As set forth in detail below, a AC-DC converter of the disclosure includes a power conversion circuit, an isolation transformer, first and second rectifier circuits, and a smoothing capacitor. In such an AC-DC converter, the output current becomes a total current of the first and second secondary currents. To obtain a desired output current, therefore, each of the first and second secondary currents becomes smaller than the current obtained when only one rectifier circuit is provided, thereby reducing the loss in the rectifier circuits. Especially when a high output current using a three-phase AC power source is required, a current flowing through a rectifier circuit becomes high, which is likely to increase the loss in the rectifier circuit.

The AC-DC converter of embodiments described in detail below can reduce the loss even when an output current is increased.

### First Embodiment

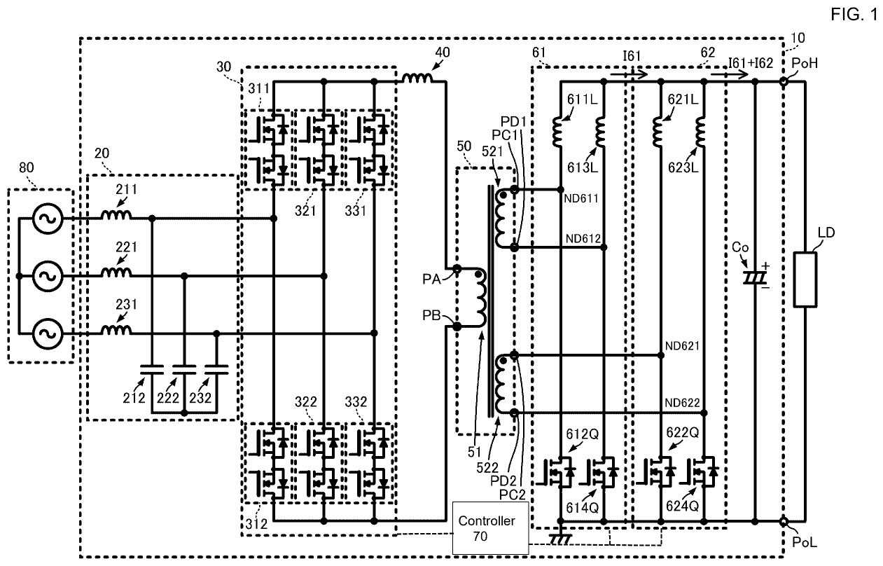

An AC-DC converter according to a first embodiment of the disclosure will be described below with reference to the drawing. FIG. 1 is a circuit diagram of the AC-DC converter according to the first embodiment. In the individual embodiments including the first embodiment, “the same”, such as the same value and the same characteristics, means that the same value includes manufacturing tolerances and the same characteristics include characteristic errors.

As illustrated in FIG. 1, an AC-DC converter 10 includes an input filter circuit 20, a power conversion circuit 30, a resonant inductor 40, an isolation transformer 50, rectifier circuits 61 and 62, and a smoothing capacitor Co. The rectifier circuit 61 corresponds to “first rectifier circuit”, and the rectifier circuit 62 corresponds to “second rectifier circuit”.

### (Schematic Configuration of AC-DC Converter 10)

The input terminal of the input filter circuit 20 is connected to the output terminal of a three-phase AC power source. The output terminal of the input filter circuit 20 is connected to the input terminal of the power conversion circuit 30. The output terminal of the power conversion circuit 30 is connected to a series circuit of the resonant inductor 40 and a primary coil 51 of the isolation transformer 50.

The isolation transformer 50 includes secondary coils 521 and 522. The secondary coils 521 and 522 are coupled with the primary coil 51 with the same degree of coupling and the same turns ratio. The secondary coil 521 corresponds to “first secondary coil”, and the secondary coil 522 corresponds to “second secondary coil”.

The output terminal of the secondary coil 521 is connected to the rectifier circuit 61. The output terminal of the secondary coil 522 is connected to the rectifier circuit 62. The rectifier circuits 61 and 62 are connected in parallel with each other. The rectifier circuit 61 corresponds to “first rectifier circuit”, and the rectifier circuit 62 corresponds to “second rectifier circuit”.

The output terminals of the rectifier circuits 61 and 62 are connected to the smoothing capacitor Co. One terminal of the smoothing capacitor Co is located close to a high-side output terminal PoH of the AC-DC converter 10, while the other terminal of the smoothing capacitor Co is located close to a low-side output terminal PoL of the AC-DC converter 10. A load LD is connected between the high-side output terminal PoH and the low-side output terminal PoL.

### (Specific Circuit Configuration of AC-DC Converter 10)

### (Input Filter Circuit 20)

The input filter circuit 20 includes inductors 211, 221, 231 and capacitors 212, 222, and 232.

One terminal of the inductor 211 is connected to a first output terminal of the three-phase AC power source 80. One terminal of the capacitor 212 is connected to the other terminal of the inductor 211. The node between this terminal of the capacitor 212 and the other terminal of the inductor 211 serves as a first output terminal of the input filter circuit 20.

One terminal of the inductor 221 is connected to a second output terminal of the three-phase AC power source 80. One terminal of the capacitor 222 is connected to the other terminal of the inductor 221. The node between this terminal of the capacitor 222 and the other terminal of the inductor 221 serves as a second output terminal of the input filter circuit 20.

One terminal of the inductor 231 is connected to a third output terminal of the three-phase AC power source 80. One terminal of the capacitor 232 is connected to the other terminal of the inductor 231. The node between this terminal of the capacitor 232 and the other terminal of the inductor 231 serves as a third output terminal of the input filter circuit 20.

The other terminals of the capacitors 212, 222, and 232 are connected to each other. In the first embodiment, as shown in FIG. 1, the capacitors 212, 222, and 232 are star-connected to each other, for example. Alternatively, the capacitors 212, 222, and 232 may be delta(Δ)-connected to each other.

With the above-described configuration, the inductor 211 and the capacitor 212 form a low-pass filter circuit for a first-phase output current of a three-phase AC; the inductor 221 and the capacitor 222 form a low-pass filter circuit for a second-phase output current of the three-phase AC; and the inductor 231 and the capacitor 232 form a low-pass filter circuit for a third-phase output current of the three-phase AC.

### (Power Conversion Circuit 30)

The power conversion circuit 30 includes switching circuits 311, 312, 321, 322, 331, and 332. The switching circuits 311, 312, 321, 322, 331, and 332 are each constituted by multiple power switching devices or switches, e.g., a transistor, and have the same electrical characteristics.

The switching circuits 311 and 312 are connected in series with each other. The node between the switching circuits 311 and 312 is connected to the first output terminal of the input filter circuit 20.

The switching circuits 321 and 322 are connected in series with each other. The node between the switching circuits 321 and 322 is connected to the second output terminal of the input filter circuit 20.

The switching circuits 331 and 332 are connected in series with each other. The node between the switching circuits 331 and 332 is connected to the third output terminal of the input filter circuit 20.

The terminal of the switching circuit 311 opposite the terminal connected to the node to the switching circuit 312, the terminal of the switching circuit 321 opposite the terminal connected to the node to the switching circuit 322, and the terminal of the switching circuit 331 opposite the terminal connected to the node to the switching circuit 332 are connected to each other. The node between these three terminals serves as a first output terminal of the power conversion circuit 30.

The terminal of the switching circuit 312 opposite the terminal connected to the node to the switching circuit 311, the terminal of the switching circuit 322 opposite the terminal connected to the node to the switching circuit 321, and the terminal of the switching circuit 332 opposite the terminal connected to the node to the switching circuit 331 are connected to each other. The node between these three terminals serves as a second output terminal of the power conversion circuit 30.

### (Isolation Transformer 50)

The isolation transformer 50 includes a primary coil 51 and secondary coils 521 and 522. The secondary coils 521 and 522 are magnetically coupled with the primary coil 51.

The primary coil 51 and the secondary coil 521 form a first transformer. The primary coil 51 and the secondary coil 522 may form a second transformer. The first and second transformers are configured to suppress magnetic coupling therebetween. The configuration in which magnetic coupling is suppressed is, for example, that the first and second transformers include different magnetic cores and the magnetic core of the first transformer and that of the second transformer are disposed separately from each other.

The degree of coupling between the primary coil 51 and the secondary coil 521 (the degree of coupling of the first transformer) is the same as the degree of coupling between the primary coil 51 and the secondary coil 522 (the degree of coupling of the second transformer). The turns ratio of the primary coil 51 to the secondary coil 521 (the turns ratio of the first transformer) is also the same as the turns ratio of the primary coil 51 to the secondary coil 522 (the turns ratio of the second transformer).

A first terminal PA of the primary coil 51 is connected to the first output terminal of the power conversion circuit 30 via the resonant inductor 40. A second terminal PB of the primary coil 51 is connected to the second output terminal of the power conversion circuit 30. In the first embodiment, the resonant inductor 40 is provided independently of the isolation transformer 50. However, a leakage inductance of the isolation transformer 50 may be used as the resonant inductor 40.

A first terminal PC1 and a second terminal PD1 of the secondary coil 521 are connected to the rectifier circuit 61. A first terminal PC2 and a second terminal PD2 of the secondary coil 522 are connected to the rectifier circuit 62.

### (Rectifier Circuits 61 and 62)

The rectifier circuits 61 and 62 are current doubler rectifier circuits and are connected in parallel with each other.

The rectifier circuit 61 includes inductors 611L and 613L and switching devices 612Q and 614Q. The switching devices 612Q and 614Q are power semiconductor switching devices. The inductors 611L and 613L have the same characteristics. The switching devices 612Q and 614Q have the same characteristics.

The inductor 611L and the switching device 612Q are connected in series with each other. The inductor 613L and the switching device 614Q are connected in series with each other. A series circuit of the inductor 611L and the switching device 612Q and a series circuit of the inductor 613L and the switching device 614Q are connected in parallel with each other.

A node ND611 between the inductor 611L and the switching device 612Q (drain terminal) is connected to the first terminal PC1 of the secondary coil 521. A node ND612 between the inductor 613L and the switching device 614Q (drain terminal) is connected to the second terminal PD1 of the secondary coil 521.

The rectifier circuit 62 includes inductors 621L and 623L and switching devices 622Q and 624Q. The switching devices 622Q and 624Q are power semiconductor switching devices. The inductors 621L and 623L have the same characteristics, which are the same as those of the inductors 611L and 613L of the rectifier circuit 61. The switching devices 622Q and 624Q have the same characteristics, which are the same as those of the switching devices 612Q and 614Q of the rectifier circuit 61.

The inductor 621L and the switching device 622Q are connected in series with each other. The inductor 623L and the switching device 624Q are connected in series with each other. A series circuit of the inductor 621L and the switching device 622Q and a series circuit of the inductor 623L and the switching device 624Q are connected in parallel with each other.

A node ND621 between the inductor 621L and the switching device 622Q (drain terminal) is connected to the first terminal PC2 of the secondary coil 522. A node ND622 between the inductor 623L and the switching device 624Q (drain terminal) is connected to the second terminal PD2 of the secondary coil 522.

The terminal of the inductor 611L opposite the terminal connected to the node ND611, the terminal of the inductor 613L opposite the terminal connected to the node ND612, the terminal of the inductor 621L opposite the terminal connected to the node ND621, and the terminal of the inductor 622L opposite the terminal connected to the node ND622 are connected to each other and are connected to the high-side output terminal PoH of the AC-DC converter 10.

The terminal (source terminal) of the switching device 612Q opposite the terminal connected to the node ND611, the terminal (source terminal) of the switching device 614Q opposite the terminal connected to the node ND612, the terminal (source terminal) of the switching device 622Q opposite the terminal connected to the node ND621, and the terminal (source terminal) of the switching device 624Q opposite the terminal connected to the node ND622 are connected to each other and are connected to the low-side output terminal PoL of the AC-DC converter 10.

### (Smoothing Capacitor Co)

The smoothing capacitor Co is connected between the high-side output terminal PoH and the low-side output terminal PoL.

### (Operation of AC-DC Converter 10)

The input filter circuit 20 filters a three-phase AC input from the three-phase AC power source 80 and outputs the resulting AC to the power conversion circuit 30. This can remove high-frequency noise, for example, contained in the three-phase AC. The AC-DC converter 10 may further include a controller 70 configured to control, as discussed in detail below, the switching operations of the switching circuits 311, 312, 321, 322, 331, and 332 in the power conversion circuit 30, and the switching devices 612Q, 614Q, 622Q, and 624Q in the rectifier circuits 61 and 62. The controller 70 generates gate drive signals to drive these switching devices to regulate the output voltage or current. The functionality of the elements disclosed herein, including the controller 70, may be implemented using circuitry or processing circuitry which includes general purpose processors, special purpose processors, integrated circuits, ASICs (“Application Specific Integrated Circuits”), FPGAs (“Field Programmable Gate Arrays”), conventional circuitry and/or combinations thereof which are programmed, using one or more programs stored in one or more memories, or otherwise configured to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein which is programmed or configured to carry out the recited functionality. Additionally, the controller 70 may utilize a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

The power conversion circuit 30 converts the three-phase AC into a single-phase AC (primary current) of a predetermined frequency and outputs the single-phase AC. The single-phase AC is supplied to the primary coil 51 of the isolation transformer 50 via the resonant inductor 40.

The secondary coil 521 of the isolation transformer 50 excites a first secondary current of a predetermined frequency (the same frequency as the primary current) from the single-phase AC (primary current) flowing through the primary coil 51 and outputs the first secondary current.

The secondary coil 522 of the isolation transformer 50 excites a second secondary current of a predetermined frequency (the same frequency as the primary current) from the single-phase AC (primary current) flowing through the primary coil 51 and outputs the second secondary current.

The isolation transformer 50 then performs voltage conversion in accordance with the turns ratio. The value of the first secondary current and that of the second secondary current are determined by the value of the primary current and the degree of coupling. The polarity of the first secondary current and that of the second secondary current are the same and the value of the first secondary current and that of the second secondary current are substantially the same.

The rectifier circuit 61 rectifies the first secondary current and generates a first rectified current I61, which is substantially a DC. The rectifier circuit 62 rectifies the second secondary current and generates a second rectified current I62, which is substantially a DC.

The rectifier circuits 61 and 62 are connected in parallel with each other. Hence, a combined current (I61+I62) of the first rectified current I61 and the second rectified current I62 flows through the load LD connected between the high-side output terminal PoH and the low-side output terminal PoL.

As described above, the AC-DC converter 10 includes the two secondary coils 521 and 522 that are independently coupled with the primary coil 51 of the isolation transformer 50. Moreover, the rectifier circuit 61 for the output current of the secondary coil 521 and the rectifier circuit 62 for the output current of the secondary coil 522 are individually provided and are connected in parallel with each other.

With the above-described configuration, in order to obtain a desired current supplied from the high-side output terminal PoH and the low-side output terminal PoL to the load ZD (output current from the AC-DC converter 10), the AC-DC converter 10 can make each of the current flowing through the rectifier circuit 61 and that through the rectifier circuit 62 smaller than the current when only one rectifier circuit is provided. More specifically, the AC-DC converter 10 can reduce the current flowing through the rectifier circuit 61 and that through the rectifier circuit 62 to half the output current. The AC-DC converter 10 can thus reduce the loss in the rectifier circuits 61 and 62.

In particular, the AC-DC converter 10 is a high-current AC-DC converter that receives the supply of power from a three-phase AC power source. In such a high-current AC-DC converter, a current flowing through the secondary coil of the isolation transformer 50 becomes high and the loss is likely to increase. Nevertheless, the AC-DC converter 10 can regulate a current flowing through the rectifier circuit 61 and that through the rectifier circuit 62, though it is a high-current AC-DC converter. That is, the AC-DC converter 10 can reduce the loss even for a high output current, thereby achieving high efficiency.

A high current handled in the first embodiment is a current of 100 A or higher that is output from the AC-DC converter 10 (current supplied to the load ZD) in one example. Even if the output current is lower than 100 A, the configuration of the AC-DC converter 10 is still applicable. Nevertheless, the configuration of the AC-DC converter 10 becomes more effective when the output current is 100 A. The output voltage is 100 V or lower and may be 12 V or 48 V, for example. If the output voltage is 48 V or higher, the configuration of a second embodiment, which will be discussed below, is more effective.

The AC-DC converter 10 uses current doubler rectifier circuits as the rectifier circuits 61 and 62. This makes it even easier to handle a high current, thereby further reducing the loss.

### Second Embodiment

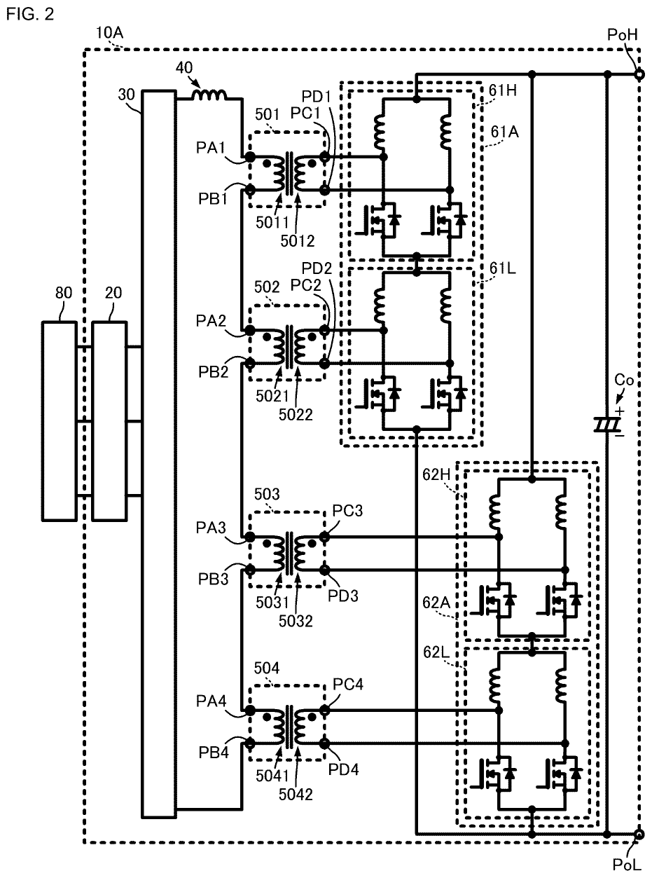

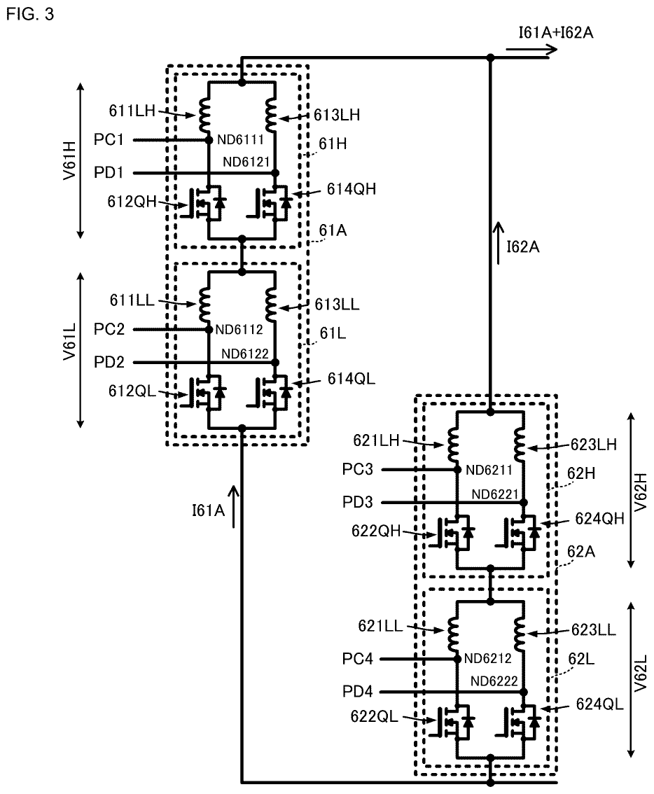

An AC-DC converter according to a second embodiment of the disclosure will be described below with reference to the drawing. FIG. 2 is a circuit diagram of the AC-DC converter according to the second embodiment. FIG. 3 is a circuit diagram of rectifier circuits connected to secondary coils of isolation transformers in the AC-DC converter of the second embodiment.

As illustrated in FIGS. 2 and 3, an AC-DC converter 10A of the second embodiment is different from the AC-DC converter 10 of the first embodiment in that the AC-DC converter 10A includes multiple isolation transformers 501 through 504 and rectifier circuits 61A and 62A. The other portions of the AC-DC converter 10A are similar to those of the AC-DC converter 10 and an explanation thereof will thus be omitted.

The AC-DC converter 10A includes an input filter circuit 20, a power conversion circuit 30, a resonant inductor 40, multiple isolation transformers 501 through 504, rectifier circuits 61A and 62A, and a smoothing capacitor Co.

### (Multiple Isolation Transformers 501 Through 504)

The isolation transformer 501 includes a primary coil 5011 and a secondary coil 5012. The primary coil 5011 and the secondary coil 5012 are coupled with a given degree of coupling and a given turns ratio. The isolation transformer 501 corresponds to “first isolation transformer”, the primary coil 5011 corresponds to “first primary coil”, and the secondary coil 5012 corresponds to “first secondary coil”.

The isolation transformer 502 includes a primary coil 5021 and a secondary coil 5022. The primary coil 5021 and the secondary coil 5022 are coupled with a given degree of coupling and a given turns ratio. The isolation transformer 502 corresponds to “third isolation transformer”, the primary coil 5021 corresponds to “third primary coil”, and the secondary coil 5022 corresponds to “third secondary coil”.

The isolation transformer 503 includes a primary coil 5031 and a secondary coil 5032. The primary coil 5031 and the secondary coil 5032 are coupled with a given degree of coupling and a given turns ratio. The isolation transformer 503 corresponds to “second isolation transformer”, the primary coil 5031 corresponds to “second primary coil”, and the secondary coil 5032 corresponds to “second secondary coil”.

The isolation transformer 504 includes a primary coil 5041 and a secondary coil 5042. The primary coil 5041 and the secondary coil 5042 are coupled with a given degree of coupling and a given turns ratio. The isolation transformer 504 corresponds to “fourth isolation transformer”, the primary coil 5041 corresponds to “fourth primary coil”, and the secondary coil 5042 corresponds to “fourth secondary coil”.

The degrees of coupling of the isolation transformers 501 through 504 are the same. The turns ratios of the isolation transformers 501 through 504 are the same. In the isolation transformers 501 through 504, the polarity of the magnetic coupling is the same.

The isolation transformers 501, 502, 503, and 504 each include one primary coil and one secondary coil and is each provided with an independent magnetic core. The isolation transformers 501, 502, 503, and 504 are arranged to avoid magnetic coupling therebetween.

The primary coil 5011 of the isolation transformer 501, the primary coil 5021 of the isolation transformer 502, the primary coil 5031 of the isolation transformer 503, and the primary coil 5041 of the isolation transformer 504 are connected in series with each other. More specifically, the primary coils 5011, 5021, 5031, and 5041 are connected in series with each other as follows. A first terminal PA1 of the primary coil 5011 is connected to the first output terminal of the power conversion circuit 30 via the resonant inductor 40. A second terminal PB1 of the primary coil 5011 is connected to a first terminal PA2 of the primary coil 5021. A second terminal PB2 of the primary coil 5021 is connected to a first terminal PA3 of the primary coil 5031. A second terminal PB3 of the primary coil 5031 is connected to a first terminal PA4 of the primary coil 5041. A second terminal PB4 of the primary coil 5041 is connected to the second output terminal of the power conversion circuit 30.

### (Rectifier Circuits 61A and 62A)

### (Rectifier Circuit 61A)

As shown in FIG. 3, the rectifier circuit 61A includes a high-side rectifier circuit 61H and a low-side rectifier circuit 61L. The high-side rectifier circuit 61H and the low-side rectifier circuit 61L are connected in series with each other. Both of the high-side rectifier circuit 61H and the low-side rectifier circuit 61L are a current doubler rectifier circuit and have the same circuit configuration. The high-side rectifier circuit 61H corresponds to “first rectifier circuit”, and the low-side rectifier circuit 61L corresponds to “third rectifier circuit”.

### (High-Side Rectifier Circuit 61H)

The high-side rectifier circuit 61H includes inductors 611LH and 613LH and switching devices 612QH and 614QH. The switching devices 612QH and 614QH are power semiconductor switching devices. The inductors 611LH and 613LH have the same characteristics. The switching devices 612QH and 614QH have the same characteristics. The inductors 611LH and 613LH correspond to “first inductor”, and the switching devices 612QH and 614QH correspond to “first switching device”.

The inductor 611LH and the switching device 612QH are connected in series with each other. The inductor 613LH and the switching device 614QH are connected in series with each other. A series circuit of the inductor 611LH and the switching device 612QH and a series circuit of the inductor 613LH and the switching device 614QH are connected in parallel with each other.

A node ND6111 between the inductor 611LH and the switching device 612QH (drain terminal) is connected to a first terminal PC1 of the secondary coil 5012. A node ND6121 between the inductor 613LH and the switching device 614QH (drain terminal) is connected to a second terminal PD1 of the secondary coil 5012.

A smoothing capacitor may be disposed between the inductor 611LH and the source terminal of the switching device 612QH. A smoothing capacitor may be disposed between the inductor 613LH and the source terminal of the switching device 614QH.

### (Low-Side Rectifier Circuit 61L)

The low-side rectifier circuit 61L includes inductors 611LL and 613LL and switching devices 612QL and 614QL. The switching devices 612QL and 614QL are power semiconductor switching devices. The inductors 611LL and 613LL have the same characteristics. The switching devices 612QL and 614QL have the same characteristics. The inductors 611LL and 613LL correspond to “third inductor”, and the switching devices 612QL and 614QL correspond to “third switching device”.

The inductor 611LL and the switching device 612QL are connected in series with each other. The inductor 613LL and the switching device 614QL are connected in series with each other. A series circuit of the inductor 611LL and the switching device 612QL and a series circuit of the inductor 613LL and the switching device 614QL are connected in parallel with each other.

A node ND6112 between the inductor 611LL and the switching device 612QL (drain terminal) is connected to a first terminal PC2 of the secondary coil 5022. A node ND6122 between the inductor 613LL and the switching device 614QL (drain terminal) is connected to a second terminal PD2 of the secondary coil 5022.

A smoothing capacitor may be disposed between the inductor 611LL and the source terminal of the switching device 612QL. A smoothing capacitor may be disposed between the inductor 613LL and the source terminal of the switching device 614QL.

### (Rectifier Circuit 62A)

As shown in FIG. 3, the rectifier circuit 62A includes a high-side rectifier circuit 62H and a low-side rectifier circuit 62L. The high-side rectifier circuit 62H and the low-side rectifier circuit 62L are connected in series with each other. Both of the high-side rectifier circuit 62H and the low-side rectifier circuit 62L are a current doubler rectifier circuit and have the same circuit configuration. The circuit configuration of the high-side rectifier circuit 62H and the low-side rectifier circuit 62L is the same as that of the high-side rectifier circuit 61H and the low-side rectifier circuit 62L. The high-side rectifier circuit 62H corresponds to “second rectifier circuit”, and the low-side rectifier circuit 62L corresponds to “fourth rectifier circuit”.

### (High-Side Rectifier Circuit 62H)

The high-side rectifier circuit 62H includes inductors 621LH and 623LH and switching devices 622QH and 624QH. The switching devices 622QH and 624QH are power semiconductor switching devices. The inductors 621LH and 623LH have the same characteristics. The switching devices 622QH and 624QH have the same characteristics. The inductors 621LH and 623LH correspond to “second inductor”, and the switching devices 622QH and 624QH correspond to “second switching device”.

The inductor 621LH and the switching device 622QH are connected in series with each other. The inductor 623LH and the switching device 624QH are connected in series with each other. A series circuit of the inductor 621LH and the switching device 622QH and a series circuit of the inductor 623LH and the switching device 624QH are connected in parallel with each other.

A node ND6211 between the inductor 621LH and the switching device 622QH (drain terminal) is connected to a first terminal PC3 of the secondary coil 5032. A node ND6221 between the inductor 623LH and the switching device 624QH (drain terminal) is connected to a second terminal PD3 of the secondary coil 5032.

A smoothing capacitor may be disposed between the inductor 621LH and the source terminal of the switching device 622QH. A smoothing capacitor may be disposed between the inductor 623LH and the source terminal of the switching device 624QH.

### (Low-Side Rectifier Circuit 62L)

The low-side rectifier circuit 62L includes inductors 621LL and 623LL and switching devices 622QL and 624QL. The switching devices 622QL and 624QL are power semiconductor switching devices. The inductors 621LL and 623LL have the same characteristics. The switching devices 622QL and 624QL have the same characteristics. The inductors 621LL and 623LL correspond to “fourth inductor”, and the switching devices 622QL and 624QL correspond to “fourth switching device”.

The inductor 621LL and the switching device 622QL are connected in series with each other. The inductor 623LL and the switching device 624QL are connected in series with each other. A series circuit of the inductor 621LL and the switching device 622QL and a series circuit of the inductor 623LL and the switching device 624QL are connected in parallel with each other.

A node ND6212 between the inductor 621LL and the switching device 622QL (drain terminal) is connected to a first terminal PC4 of the secondary coil 5042. A node ND6222 between the inductor 623LL and the switching device 624QL (drain terminal) is connected to a second terminal PD4 of the secondary coil 5042.

A smoothing capacitor may be disposed between the inductor 621LL and the source terminal of the switching device 622QL. A smoothing capacitor may be disposed between the inductor 623LL and the source terminal of the switching device 624QL.

### (Connection Mode Between Rectifier Circuits 61A and 62A)

The rectifier circuits 61A and 62A are connected in parallel with each other. More specifically, one terminal of the inductor 611LH of the high-side rectifier circuit 61H of the rectifier circuit 61A (the terminal of the inductor 611LH opposite the terminal connected to the node ND6111), one terminal of the inductor 613LH of the high-side rectifier circuit 61H of the rectifier circuit 61A (the terminal of the inductor 613LH opposite the terminal connected to the node ND6121), one terminal of the inductor 621LH of the high-side rectifier circuit 62H of the rectifier circuit 62A (the terminal of the inductor 621LH opposite the terminal connected to the node ND6211), and one terminal of the inductor 623LH of the high-side rectifier circuit 62H of the rectifier circuit 62A (the terminal of the inductor 623LH opposite the terminal connected to the node ND6221) are connected to each other and are connected to the high-side output terminal PoH of the AC-DC converter 10A.

One terminal (source terminal) of the switching device 612QL of the low-side rectifier circuit 61L of the rectifier circuit 61A, which is opposite the terminal of the switching device 612QL connected to the node ND6112, one terminal (source terminal) of the switching device 614QL of the low-side rectifier circuit 61L of the rectifier circuit 61A, which is opposite the terminal of the switching device 614QL connected to the node ND6122, one terminal (source terminal) of the switching device 622QL of the low-side rectifier circuit 62L of the rectifier circuit 62A, which is opposite the terminal of the switching device 622QL connected to the node ND6212, and one terminal (source terminal) of the switching device 624QL of the low-side rectifier circuit 62L of the rectifier circuit 62A, which is opposite the terminal of the switching device 624QL connected to the node ND6222, are connected to each other and are connected to the low-side output terminal PoL of the AC-DC converter 10A.

With the above-described configuration, in order to obtain a desired current supplied from the high-side output terminal PoH and the low-side output terminal PoL to the load ZD (output current from the AC-DC converter 10A), the AC-DC converter 10A can make each of the current flowing through the rectifier circuit 61A and that through the rectifier circuit 62A smaller than the current when only one rectifier circuit is provided. More specifically, the AC-DC converter 10A can reduce the current flowing through the rectifier circuit 61A and that through the rectifier circuit 62A to half the output current. The AC-DC converter 10A can thus reduce the loss in the rectifier circuits 61A and 62A.

Additionally, with the above-described configuration, the voltage V61A applied to the rectifier circuit 61A becomes the combined voltage of the voltage V61H applied to the high-side rectifier circuit 61H and the voltage V61L applied to the low-side rectifier circuit 61L. With respect to the desired output voltage of the AC-DC converter 10A, the voltage applied to the switching devices 612QL and 614QL of the low-side rectifier circuit 61L and the voltage applied to the switching devices 612QH and 614QH of the high-side rectifier circuit 61H can be reduced. The reduced voltages are 100 V or lower, for example.

This makes it possible to set a lower withstand voltage for the switching devices 612QL and 614QL of the low-side rectifier circuit 61L and the switching devices 612QH and 614QH of the high-side rectifier circuit 61H. As the withstand voltage of a switching device is higher, the ON-resistance of the switching device also becomes higher. A lower withstand voltage can thus reduce the conduction loss of the switching devices 612QL, 614QL, 612QH, and 614QH.

Likewise, the voltage V62A applied to the rectifier circuit 62A becomes the combined voltage of the voltage V62H applied to the high-side rectifier circuit 62H and the voltage V62L applied to the low-side rectifier circuit 62L. With respect to the desired output voltage of the AC-DC converter 10A, the voltage applied to the switching devices 622QL and 624QL of the low-side rectifier circuit 62L and the voltage applied to the switching devices 622QH and 624QH of the high-side rectifier circuit 62H can be reduced.

This makes it possible to set a lower withstand voltage for the switching devices 622QL and 624QL of the low-side rectifier circuit 62L and the switching devices 622QH and 624QH of the high-side rectifier circuit 62H. As the withstand voltage of a switching device is higher, the ON-resistance of the switching device also becomes higher. A lower withstand voltage can thus reduce the conduction loss of the switching devices 622QL, 624QL, 622QH, and 624QH.

As a result, the AC-DC converter 10A can reduce the loss even for a high output current and can also reduce the loss even for a high output voltage, thereby achieving even higher efficiency.

A high voltage in the second embodiment refers to that the output voltage from the AC-DC converter 10 is about 48 V, for example.

In the AC-DC converter 10A, the primary coil and the secondary coil are coupled with each other at a ratio of 1:1, and multiple independent transformers are used. This configuration decreases a disparity in the degree of coupling, namely, a difference between the degree of coupling of one secondary coil with a primary coil and that of another secondary coil with this primary coil, which can be observed in a transformer including multiple secondary coils coupled with one primary coil. This can lower the difference between a current flowing through the rectifier circuit 61A and that through the rectifier circuit 62A, resulting in a smaller loss in the rectifier circuit through which a high current flows.

“Independent transformers” means that the transformers are disposed separately from each other, for example.

In the second embodiment, the isolation transformers 501 through 504 are each provided with an independent magnetic core. However, for example, multiple isolation transformers may be formed using one magnetic core, such as an EI core, if magnetic coupling between the isolation transformers is suppressed.

### (Structure of AC-DC Converter 10A)

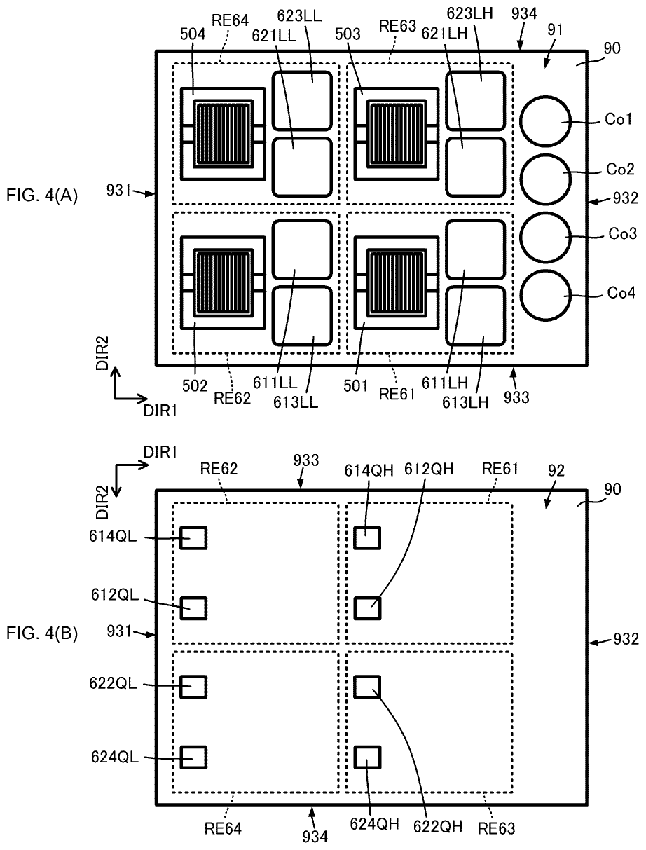

FIG. 4(A) and FIG. 4(B) illustrate the configuration of a circuit module that implements a circuit from the isolation transformers to the output terminal of the AC-DC converter of the second embodiment. FIG. 4(A) is a plan view when a first surface is seen from above, and FIG. 4(B) is a plan view when a second surface is seen from above.

As illustrated in FIG. 4(A) and FIG. 4(B), the AC-DC converter 10A includes a circuit substrate 90. The circuit substrate 90 has a first surface 91, a second surface 92, and multiple side surfaces 931, 932, 933, and 934. The first surface 91 is a surface of one end of the circuit substrate 90 in the thickness direction. The second surface 92 is a surface of the other end of the circuit substrate 90 in the thickness direction. The side surfaces 931 and 932 are located on two ends of the first surface 91 and the second surface 92 in a first direction (DIR1) and oppose each other. The side surfaces 933 and 934 are located on two ends of the first surface 91 and the second surface 92 in a second direction (DIR2) and oppose each other.

### (Mounting Mode on First Surface 91)

The isolation transformers 501, 502, 503, and 504, the inductors 611LH, 613LH, 611LL, 613LL, 621LH, 623LH, 621LL, and 623LL, and capacitors Co1, Co2, Co3, and Co4 are mounted on the first surface 91. The capacitors Co1, Co2, Co3, and Co4 form the smoothing capacitor Co.

The first surface 91 includes a first region RE61, a second region RE62, a third region RE63, and a fourth region RE64. The first region RE61 and the second region RE62 are arranged side by side in the first direction (DIR1). The third region RE63 and the fourth region RE64 are arranged side by side in the first direction (DIR1). The first region RE61 and the third region RE63 are arranged side by side in the second direction (DIR2). The second region RE62 and the fourth region RE64 are arranged side by side in the second direction (DIR2). That is, the first region RE61, second region RE62, third region RE63, and fourth region RE64 are arranged in a two-dimensional matrix on the first surface 91.

More specifically, the first region RE61 and the second region RE62 are adjacent to each other in the first direction (DIR1) and are arranged in the order of the second region RE62 and the first region RE61 in the direction from the side surface 931 to the side surface 932. The third region RE63 and the fourth region RE64 are adjacent to each other in the first direction (DIR1) and are arranged in the order of the fourth region RE64 and the third region RE63 in the direction from the side surface 931 to the side surface 932.

The first region RE61 and the third region RE63 are adjacent to each other in the second direction (DIR2) and are arranged in the order of the first region RE61 and the third region RE63 in the direction from the side surface 933 to the side surface 934. The second region RE62 and the fourth region RE64 are adjacent to each other in the second direction (DIR2) and are arranged in the order of the second region RE62 and the fourth region RE64 in the direction from the side surface 933 to the side surface 934.

The smoothing capacitor Co (capacitors Co1, Co2, Co3, and Co4) is disposed between the first and third regions RE61 and RE63 and the side surface 932 in the first direction DIR1.

In the first region RE61, the isolation transformer 501 and the inductors 611LH and 613LH are mounted. The isolation transformer 501 and the inductors 611LH and 613LH are arranged side by side in the first direction. The isolation transformer 501 is disposed closer to the side surface 931 than the inductors 611LH and 613LH are. The inductors 611LH and 613LH are arranged side by side in the second direction. The inductor 613LH is disposed closer to the side surface 933 than the inductor 611LH is.

In the second region RE62, the isolation transformer 502 and the inductors 611LL and 613LL are mounted. The isolation transformer 502 and the inductors 611LL and 613LL are arranged side by side in the first direction. The isolation transformer 502 is disposed closer to the side surface 931 than the inductors 611LL and 613LL are. The inductors 611LL and 613LL are arranged side by side in the second direction. The inductor 613LL is disposed closer to the side surface 933 than the inductor 611LL is.

In the third region RE63, the isolation transformer 503 and the inductors 621LH and 623LH are mounted. The isolation transformer 503 and the inductors 621LH and 623LH are arranged side by side in the first direction. The isolation transformer 503 is disposed closer to the side surface 931 than the inductors 621LH and 623LH are. The inductors 621LH and 623LH are arranged side by side in the second direction. The inductor 623LH is disposed closer to the side surface 934 than the inductor 621LH is.

In the fourth region RE64, the isolation transformer 504 and the inductors 621LL and 623LL are mounted. The isolation transformer 504 and the inductors 621LL and 623LL are arranged side by side in the first direction. The isolation transformer 504 is disposed closer to the side surface 931 than the inductors 621LL and 623LL are. The inductors 621LL and 623LL are arranged side by side in the second direction. The inductor 623LL is disposed closer to the side surface 934 than the inductor 621LL is.

### (Mounting Mode on Second Surface 92)

The switching devices 612QH, 614QH, 612QL, 614QL, 622QH, 624QH, 622QL, and 624QL are mounted on the second surface 92.

The switching devices 612QH and 614QH are mounted on the second surface 92 in a region corresponding to the first region RE61. The switching device 614QH is disposed closer to the side surface 933 than the switching device 612QH is.

The switching devices 612QL and 614QL are mounted on the second surface 92 in a region corresponding to the second region RE62. The switching device 614QL is disposed closer to the side surface 933 than the switching device 612QL is.

The switching devices 622QH and 624QH are mounted on the second surface 92 in a region corresponding to the third region RE63. The switching device 624QH is disposed closer to the side surface 934 than the switching device 622QH is.

The switching devices 622QL and 624QL are mounted on the second surface 92 in a region corresponding to the fourth region RE64. The switching device 624QL is disposed closer to the side surface 934 than the switching device 622QL is.

With the above-described configuration, the AC-DC converter 10A forms a circuit constituted by the isolation transformer 501 and the high-side rectifier circuit 61H in the first region RE61 and a circuit constituted by the isolation transformer 502 and the low-side rectifier circuit 61L in the second region RE62. The AC-DC converter 10A also forms a circuit constituted by the isolation transformer 503 and the high-side rectifier circuit 62H in the third region RE63 and a circuit constituted by the isolation transformer 504 and the low-side rectifier circuit 62L in the fourth region RE64.

Hence, the AC-DC converter 10A can form the circuit constituted by the isolation transformer 501 and the high-side rectifier circuit 61H, the circuit constituted by the isolation transformer 502 and the low-side rectifier circuit 61L, the circuit constituted by the isolation transformer 503 and the high-side rectifier circuit 62H, and the circuit constituted by the isolation transformer 504 and the low-side rectifier circuit 62L with simpler, shorter wiring patterns. The AC-DC converter 10A can thus reduce the loss caused by the wiring patterns.

Additionally, in the AC-DC converter 10A, the isolation transformers and the inductors of the rectifier circuits are mounted on the first surface 91, while the switching devices of the rectifier circuits are mounted on the second surface 92. In this configuration, wiring patterns for the rectifier circuits can be made even simpler and shorter by the use of wiring patterns for interlayer connection conductors provided in the circuit substrate 90, for example. The AC-DC converter 10A can thus further reduce the loss caused by the wiring patterns.

The high-side rectifier circuit 61H, high-side rectifier circuit 62H, low-side rectifier circuit 61L, and low-side rectifier circuit 62L are individually formed in the corresponding regions of the circuit substrate 90. The AC-DC converter 10A can thus reduce undesired coupling between the high-side rectifier circuit 61H, high-side rectifier circuit 62H, low-side rectifier circuit 61L, and low-side rectifier circuit 62L.

The high-side rectifier circuit 61H and the low-side rectifier circuit 61L forming the rectifier circuit 61A are arranged on the circuit substrate 90 in the first direction DIR1. The high-side rectifier circuit 62H and the low-side rectifier circuit 62L forming the rectifier circuit 62A are arranged on the circuit substrate 90 in the first direction. This makes it possible to separate wiring patterns of circuit conductor patterns for the rectifier circuit 61A formed on the circuit substrate 90 from those of the rectifier circuit 62A on the circuit substrate 90.

In the rectifier circuit 61A, the low-side rectifier circuit 61L and the high-side rectifier circuits 61H are arranged in this order along the first direction DIR1. In the rectifier circuit 62A, the low-side rectifier circuit 62L and the high-side rectifier circuits 62H are arranged in this order along the first direction DIR1. With this arrangement, the wiring patterns can be made even simpler and shorter. The capacitors Co1, Co2, Co3, and Co4 are disposed at a position closer to the side surface 932 than the other elements in the first direction DIR1. This can make the wiring patterns even simpler and shorter for the elements including the smoothing capacitor Co (capacitors Co1, Co2, Co3, and Co4).

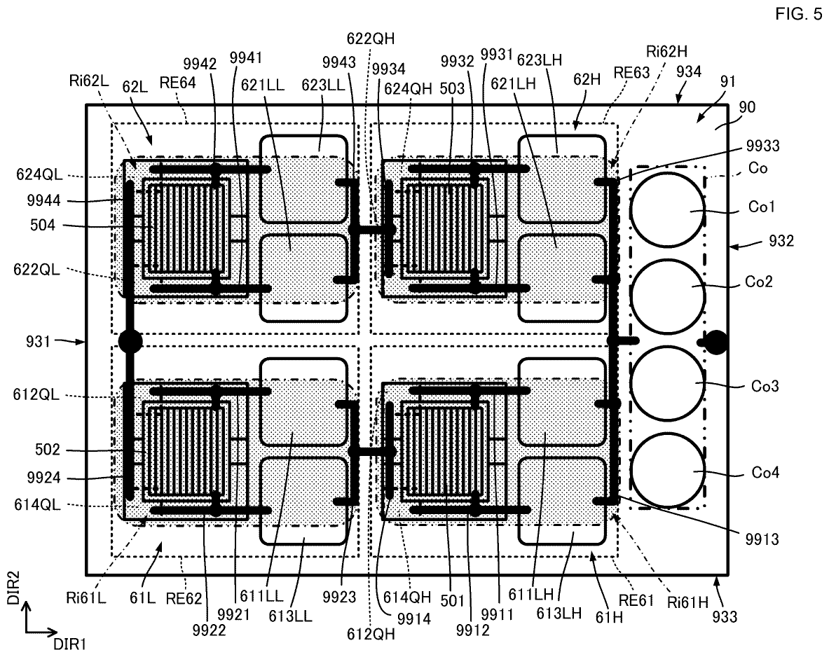

The low-side rectifier circuit 61L, high-side rectifier circuit 61H, low-side rectifier circuit 62L, and high-side rectifier circuit 62H are connected with wiring patterns as shown in FIG. 5. FIG. 5 illustrates an example of wiring patterns for the rectifier circuits. FIG. 5 shows the wiring patterns on the circuit substrate 90 when the first surface 91 is seen from above. The solid thick lines in FIG. 5 indicate the wiring patterns (conductor patterns). Each wiring pattern is constituted by a linear conductor pattern formed on the first surface 91 or the second surface 92 or an interlayer connection conductor extending in the thickness direction of the circuit substrate 90.

### (Low-Side Rectifier Circuit 61L and High-Side Rectifier Circuit 61H)

Regarding the low-side rectifier circuit 61L and the high-side rectifier circuit 61H, along the first direction DIR1, the isolation transformer 502, inductors 611LL and 613LL, isolation transformer 501, inductors 611LH and 613LH, and smoothing capacitor Co (capacitors Co1, Co2, Co3, and Co4) are disposed in this order on the first surface 91 of the circuit substrate 90.

In the high-side rectifier circuit 61H, the inductor 611LH and the drain terminal of the switching device 612QH are connected to each other with a wiring pattern 9911. The inductor 613LH and the drain terminal of the switching device 614QH are connected to each other with a wiring pattern 9912.

The isolation transformer 501 is disposed between the wiring patterns 9911 and 9912. The first terminal PC1 is connected to the wiring pattern 9911, while the second terminal PD1 is connected to the wiring pattern 9912.

The inductors 611LH and 613LH are connected to each other with a wiring pattern 9913. The source terminal of the switching device 612QH and the source terminal of the switching device 614QH are connected to each other with a wiring pattern 9914.

The positive electrode of the smoothing capacitor Co is connected to the wiring pattern 9913. The wiring pattern 9914 is connected to a wiring pattern 9923 forming the low-side rectifier circuit 61L.

In the low-side rectifier circuit 61L, the inductor 611LL and the drain terminal of the switching device 612QL are connected to each other with a wiring pattern 9921. The inductor 613LL and the drain terminal of the switching device 614QL are connected to each other with a wiring pattern 9922.

The isolation transformer 502 is disposed between the wiring patterns 9921 and 9922. The first terminal PC2 is connected to the wiring pattern 9921, while the second terminal PD2 is connected to the wiring pattern 9922.

The inductors 611LL and 613LL are connected to each other with the wiring pattern 9923. The source terminal of the switching device 612QL and the source terminal of the switching device 614QL are connected to each other with a wiring pattern 9924.

The negative electrode of the smoothing capacitor Co is connected to the wiring pattern 9924 with an inner layer of the substrate interposed therebetween. The wiring pattern 9923 is connected to the wiring pattern 9914 forming the high-side rectifier circuit 61H.

In the above-described configuration, the structure of the wiring pattern constituted by the wiring patterns 9911, 9912, 9913, and 9914 in the high-side rectifier circuit 61H and that of the wiring pattern constituted by the wiring patterns 9921, 9922, 9923, and 9924 in the low-side rectifier circuit 61L are identical to each other.

Hence, the line length of a current loop Ri61L in the low-side rectifier circuit 61L and that of a current loop Ri61H in the high-side rectifier circuit 61H can be equal to each other. With this configuration, the parasitic inductance formed in the current loop Ri61L and that in the current loop Ri61H can be substantially the same level, so that the surge voltage occurring in the switching devices in the low-side rectifier circuit 61L and that in the high-side rectifier circuit 61H also become substantially the same level.

### (Low-Side Rectifier Circuit 62L and High-Side Rectifier Circuit 62H)

Regarding the low-side rectifier circuit 62L and the high-side rectifier circuit 62H, along the first direction DIR1, the isolation transformer 504, inductors 621LL and 623LL, isolation transformer 503, inductors 621LH and 623LH, and smoothing capacitor Co (capacitors Co1, Co2, Co3, and Co4) are disposed in this order on the first surface 91 of the circuit substrate 90.

In the high-side rectifier circuit 62H, the inductor 621LH and the drain terminal of the switching device 622QH are connected to each other with a wiring pattern 9931. The inductor 623LH and the drain terminal of the switching device 624QH are connected to each other with a wiring pattern 9932.

The isolation transformer 503 is disposed between the wiring patterns 9931 and 9932. The first terminal PC3 is connected to the wiring pattern 9931, while the second terminal PD3 is connected to the wiring pattern 9932.

The inductors 621LH and 623LH are connected to each other with a wiring pattern 9933. The source terminal of the switching device 622QH and the source terminal of the switching device 624QH are connected to each other with a wiring pattern 9934.

The positive electrode of the smoothing capacitor Co is connected to the wiring pattern 9933. The wiring pattern 9934 is connected to a wiring pattern 9943 forming the low-side rectifier circuit 62L.

In the low-side rectifier circuit 62L, the inductor 621LL and the drain terminal of the switching device 622QL are connected to each other with a wiring pattern 9941. The inductor 623LL and the drain terminal of the switching device 624QL are connected to each other with a wiring pattern 9942.

The isolation transformer 504 is disposed between the wiring patterns 9941 and 9942. The first terminal PC4 is connected to the wiring pattern 9941, while the second terminal PD4 is connected to the wiring pattern 9942.

The inductors 621LL and 623LL are connected to each other with the wiring pattern 9943. The source terminal of the switching device 622QL and the source terminal of the switching device 624QL are connected to each other with a wiring pattern 9944.

The negative electrode of the smoothing capacitor Co is connected to the wiring pattern 9944 with an inner layer of the substrate interposed therebetween. The wiring pattern 9943 is connected to the wiring pattern 9934 forming the high-side rectifier circuit 62H.

With the above-described configuration, the structure of the wiring pattern constituted by the wiring patterns 9931, 9932, 9933, and 9934 in the high-side rectifier circuit 62H and that of the wiring pattern constituted by the wiring patterns 9941, 9942, 9943, and 9944 in the low-side rectifier circuit 62L are identical to each other.

Hence, the line length of a current loop Ri62L in the low-side rectifier circuit 62L and that of a current loop Ri62H in the high-side rectifier circuit 62H can be equal to each other. With this configuration, the parasitic inductance formed in the current loop Ri62L and that in the current loop Ri62H can be substantially the same level, so that the surge voltage occurring in the switching devices in the low-side rectifier circuit 62L and that in the high-side rectifier circuit 62H also become substantially the same level.

The line length of the current loop Ri61L in the low-side rectifier circuit 61L, the line length of the current loop Ri61H in the high-side rectifier circuit 61H, the line length of the current loop Ri62L in the low-side rectifier circuit 62L, the line length of the current loop Ri62H in the high-side rectifier circuit 62H are equal to each other. This can make the surge voltages occurring in the switching devices of all the matching circuits can be substantially the same level.

The isolation transformers 501 through 504 are disposed with a space therebetween. This can reduce undesired coupling between the isolation transformers 501 through 504.

Multiple isolation transformers, multiple inductors, and multiple switching devices are provided, so that the power loss per component can become smaller, resulting in better heat distribution.

Additionally, high-profile components, such as the isolation transformers, inductors, and capacitors, are mounted on the first surface 91, while low-profile components, such as the switching devices, are mounted on the second surface 92. This can reduce the height of the circuit module.

### Third Embodiment

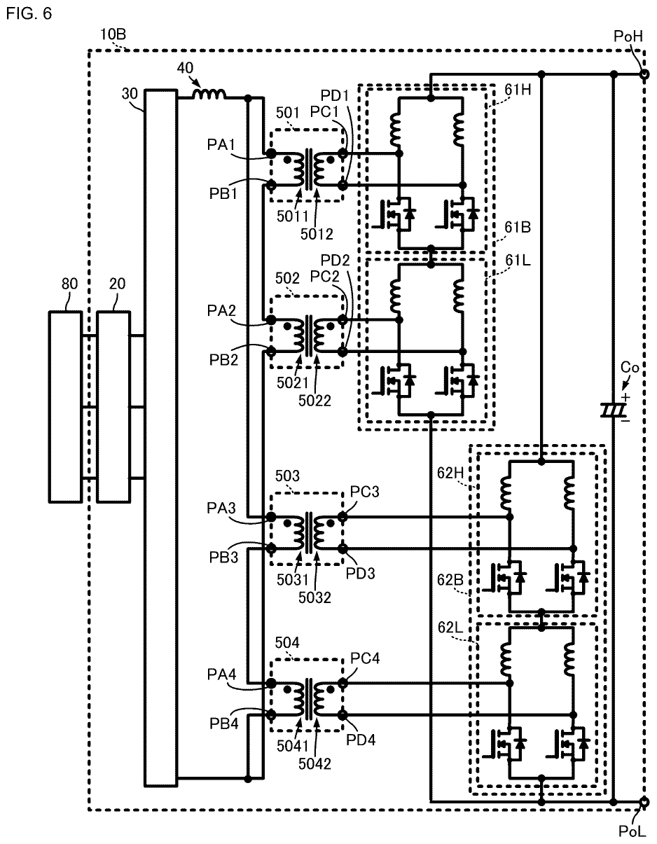

An AC-DC converter according to a third embodiment of the disclosure will be described below with reference to the drawing. FIG. 6 is a circuit diagram of the AC-DC converter according to the third embodiment.

As illustrated in FIG. 6, an AC-DC converter 10B according to the third embodiment is different from the AC-DC converter 10A according to the second embodiment in that the connection pattern of the isolation transformers 501 through 504 is different from that in the second embodiment. The other portions of the AC-DC converter 10B are similar to those of the AC-DC converter 10A and an explanation thereof will thus be omitted.

The isolation transformers 501 and 502 are connected in series with each other. The isolation transformers 503 and 504 are connected in series with each other. A series circuit of the isolation transformers 501 and 502 and a series circuit of the isolation transformers 503 and 504 are connected in parallel with each other.

With the above-described configuration, the AC-DC converter 10B can achieve advantages similar to those of the AC-DC converter 10A. Additionally, in the AC-DC converter 10B, currents flowing through the primary coils of the isolation transformers 501 through 504 are decreased. Hence, especially when the primary current is high, the AC-DC converter 10B can reduce the core loss occurring in the isolation transformers 501 through 504, thereby achieving even higher efficiency.

### Fourth Embodiment

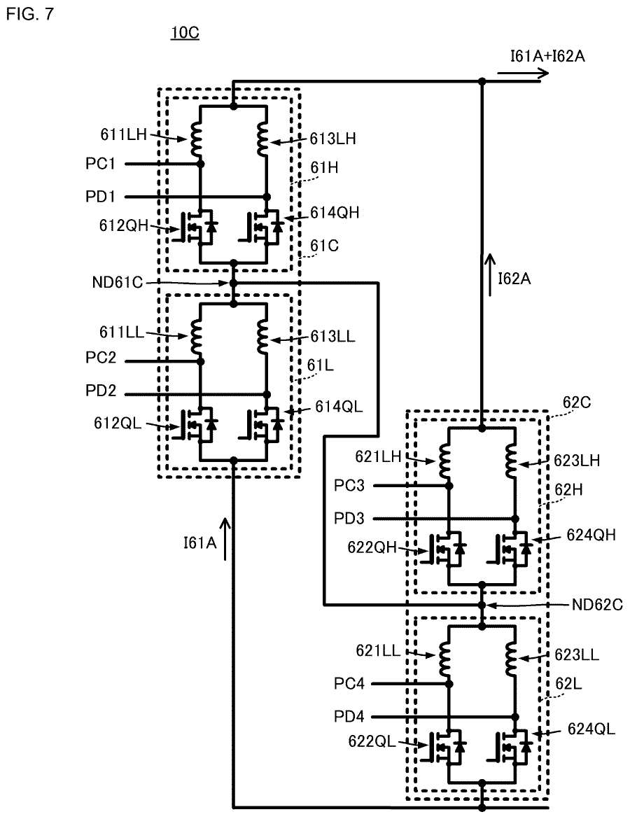

An AC-DC converter according to a fourth embodiment of the disclosure will be described below with reference to the drawing. FIG. 7 is a circuit diagram of rectifier circuits of the AC-DC converter according to the fourth embodiment.

As illustrated in FIG. 7, an AC-DC converter 10C of the fourth embodiment is different from the AC-DC converter 10A of the second embodiment in that the intermediate potential of a rectifier circuit 61C and that of a rectifier circuit 62C are short-circuited. The other portions of the AC-DC converter 10C are similar to those of the AC-DC converter 10A and an explanation thereof will thus be omitted.

The configuration of the rectifier circuit 61C is similar to that of the rectifier circuit 61A, and the configuration of the rectifier circuit 62C is similar to that of the rectifier circuit 62A.

A node ND61C between a high-side rectifier circuit 61H and a low-side rectifier circuit 61L of the rectifier circuit 61C and a node ND62C between a high-side rectifier circuit 62H and a low-side rectifier circuit 62L of the rectifier circuit 62C are electrically connected to each other.

With this configuration, the AC-DC converter 10C is able to match the source potential of the switching devices forming the high-side rectifier circuit 61H with the source potential of the switching devices forming the high-side rectifier circuit 62H, in addition to achieving advantages similar to those of the AC-DC converter 10A. The AC-DC converter 10C can thus simplify a drive circuit for the switching devices of the high-side rectifier circuits 61H and 62H.

### Fifth Embodiment

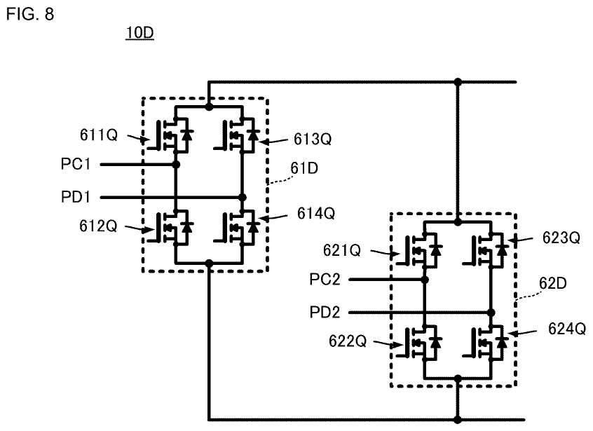

An AC-DC converter according to a fifth embodiment of the disclosure will be described below with reference to the drawing. FIG. 8 is a circuit diagram of rectifier circuits of the AC-DC converter according to the fifth embodiment.

As illustrated in FIG. 8, an AC-DC converter 10D of the fifth embodiment is different from the AC-DC converter 10 of the first embodiment in that it includes rectifier circuits 61D and 62D. The other portions of the AC-DC converter 10D are similar to those of the AC-DC converter 10 and an explanation thereof will thus be omitted.

The AC-DC converter 10D includes rectifier circuits 61D and 62D.

The rectifier circuit 61D is a full-wave rectifier circuit (full-bridge rectifier circuit) using four switching devices 611Q, 612Q, 613Q, and 614Q. The rectifier circuit 61D is connected to the secondary coil 521.

The rectifier circuit 62D is a full-wave rectifier circuit (full-bridge rectifier circuit) using four switching devices 621Q, 622Q, 623Q, and 624Q. The rectifier circuit 62D is connected to the secondary coil 522.

The rectifier circuits 61D and 62D are connected in parallel with each other.

With this configuration, the AC-DC converter 10D can achieve advantages similar to those of the AC-DC converter 10.

### Sixth Embodiment

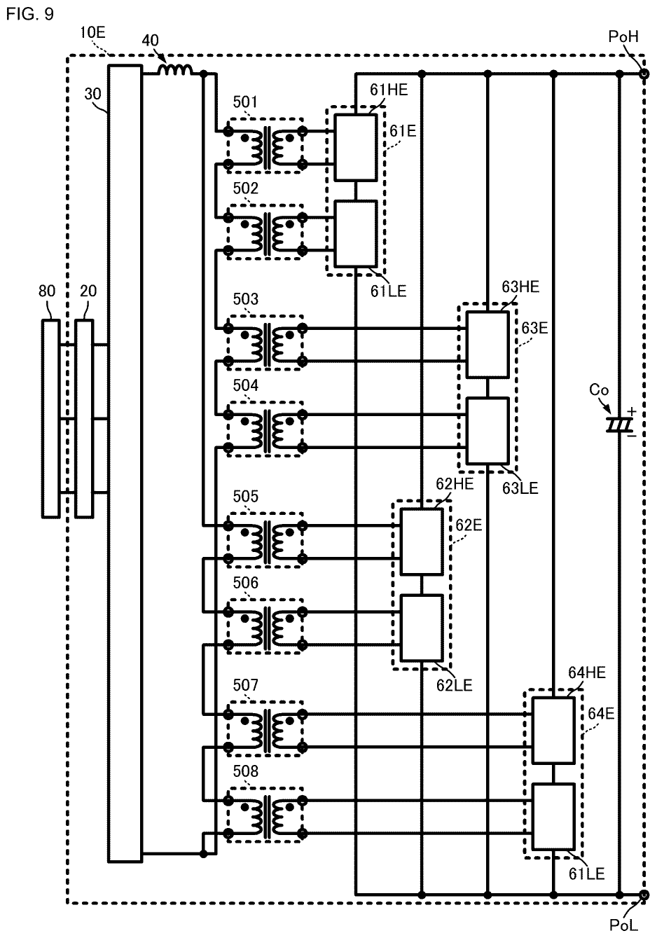

An AC-DC converter according to a sixth embodiment of the disclosure will be described below with reference to the drawing. FIG. 9 is a circuit diagram of the AC-DC converter according to the sixth embodiment.

As illustrated in FIG. 9, an AC-DC converter 10E of the sixth embodiment is different from the AC-DC converter 10 of the first embodiment in that it includes eight isolation transformers 501 through 508 and four rectifier circuits 61E through 64E. The other portions of the AC-DC converter 10E are similar to those of the AC-DC converter 10 and an explanation thereof will thus be omitted.

The AC-DC converter 10E includes multiple (eight) isolation transformers 501 through 508 and multiple (four) rectifier circuits 61E through 64E.

The isolation transformers 501 through 508 each include one primary coil and one secondary coil and are each provided with an independent magnetic core.

The primary coils of the isolation transformers 501 through 504 are connected in series with each other. The primary coils of the isolation transformers 505 through 508 are connected in series with each other. A series circuit of the primary coils of the isolation transformers 501 through 504 and a series circuit of the primary coils of the isolation transformers 505 through 508 are connected in parallel with each other. Alternatively, in one example, the primary coils of the isolation transformers 501 through 508 may be connected in series with each other. In another example, the primary coils of two isolation transformers may be connected in series with each other to form a series circuit, and four such series circuits may be connected in parallel with each other.

The rectifier circuits 61E through 64E are connected in parallel with each other. The rectifier circuit 61E is constituted by a series circuit of a high-side rectifier circuit 61HE and a low-side rectifier circuit 61LE. The rectifier circuit 62E is constituted by a series circuit of a high-side rectifier circuit 62HE and a low-side rectifier circuit 62LE. The rectifier circuit 63E is constituted by a series circuit of a high-side rectifier circuit 63HE and a low-side rectifier circuit 63LE. The rectifier circuit 64E is constituted by a series circuit of a high-side rectifier circuit 64HE and a low-side rectifier circuit 64LE.

The circuit configuration of the high-side rectifier circuits 61HE, 62HE, 63HE, and 64HE is the same as the high-side rectifier circuit 61H in the second embodiment. The circuit configuration of the low-side rectifier circuits 61LE, 62LE, 63LE, and 64LE is the same as the low-side rectifier circuit 61L in the second embodiment.

With the above-described configuration, in order to obtain a desired output current, the AC-DC converter 10E can reduce the current flowing through each of the rectifier circuits 61E through 64E to one fourth of the output current. The AC-DC converter 10E can also reduce the voltage applied to the switching devices of the high-side rectifier circuits forming the rectifier circuits 61E through 64E and the voltage applied to the switching devices of the low-side rectifier circuits forming the rectifier circuits 61E through 64E to half the output voltage.

This allows the AC-DC converter 10E to reduce the loss even when a higher current is input and even when the voltage is increased to a certain degree.

The number of parallel-connected rectifier circuits is not limited to four. The number of series-connected rectifier circuits forming each of the parallel-connected rectifier circuits is not limited to two, either. The number of parallel-connected rectifier circuits and the number of series-connected rectifier circuits can be set suitably based on the electrical specifications (output current and output voltage) required for the AC-DC converter.

### Seventh Embodiment

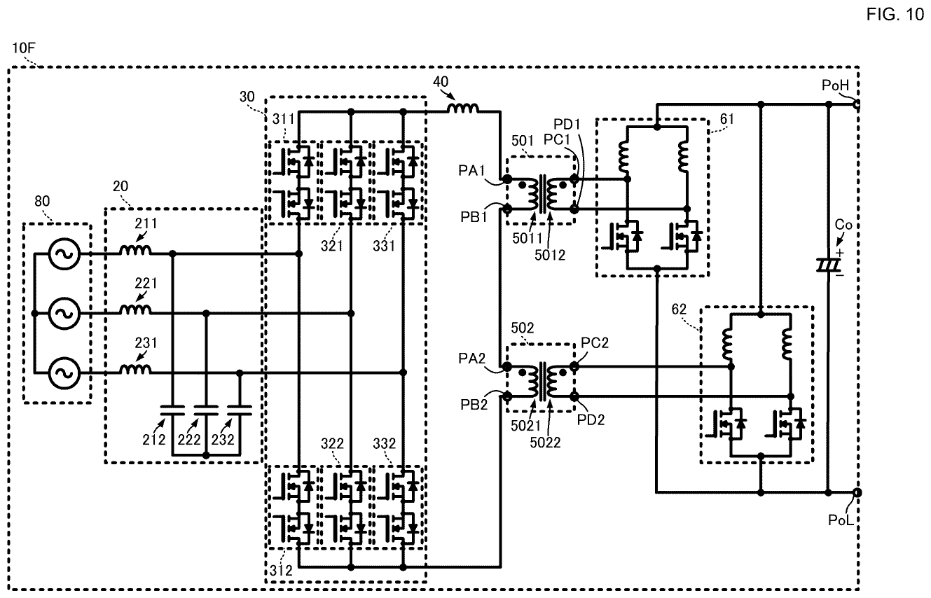

An AC-DC converter according to a seventh embodiment of the disclosure will be described below with reference to the drawing. FIG. 10 is a circuit diagram of the AC-DC converter according to the seventh embodiment.

As illustrated in FIG. 10, an AC-DC converter 10F of the seventh embodiment is different from the AC-DC converter 10 of the first embodiment in the configuration of the isolation transformers. The other portions of the AC-DC converter 10F are similar to those of the AC-DC converter 10 and an explanation thereof will thus be omitted.

The AC-DC converter 10F includes isolation transformers 501 and 502.

The isolation transformer 501 includes a primary coil 5011 and a secondary coil 5012. The primary coil 5011 and the secondary coil 5012 are coupled with a given degree of coupling and a given turns ratio. The primary coil 5011 corresponds to “first primary coil”, and the secondary coil 5012 corresponds to “first secondary coil”.

The isolation transformer 502 includes a primary coil 5021 and a secondary coil 5022. The primary coil 5021 and the secondary coil 5022 are coupled with a given degree of coupling and a given turns ratio. The primary coil 5021 corresponds to “second primary coil”, and the secondary coil 5022 corresponds to “second secondary coil”.

The degree of coupling of the isolation transformer 501 and that of the isolation transformer 502 are the same. The turns ratio of the primary coil to the secondary coil in the isolation transformer 501 and that of the isolation transformer 502 are the same.

The isolation transformers 501 and 502 are each provided with an independent magnetic core. The isolation transformers 501 and 502 are arranged to avoid magnetic coupling therebetween. The isolation transformer 501 corresponds to “first transformer”, and the isolation transformer 502 corresponds to “second transformer”.

The primary coil 5011 of the isolation transformer 501 and the primary coil 5021 of the isolation transformer 502 are connected in series with each other. More specifically, the primary coils 5011 and 5021 are connected in the following manner. A first terminal PA1 of the primary coil 5011 is connected to the first output terminal of the power conversion circuit 30 via the resonant inductor 40. A second terminal PB1 of the primary coil 5011 is connected to a first terminal PA2 of the primary coil 5021. A second terminal PB2 of the primary coil 5021 is connected to the second output terminal of the power conversion circuit 30.

The secondary coil 5012 of the isolation transformer 501 is connected to the rectifier circuit 61. The secondary coil 5022 of the isolation transformer 502 is connected to the rectifier circuit 62.

With the above-described configuration, the AC-DC converter 10F can achieve advantages similar to those of the AC-DC converter 10 of the first embodiment.

In the AC-DC converter 10F, the primary coil 5011 of the isolation transformer 501 and the primary coil 5021 of the isolation transformer 502 are connected in series with each other. The current flowing through the primary coil 5011 and that through the primary coil 5021 thus become equal to each other. The degree of coupling between the primary coil 5011 and the secondary coil 5012 of the isolation transformer 501 is the same as that between the primary coil 5021 and the secondary coil 5022 of the isolation transformer 502. The turns ratio of the primary coil 5011 to the secondary coil 5012 in the isolation transformer 501 is the same as that of the primary coil 5021 to the secondary coil 5022 in the isolation transformer 502.

Hence, a current flowing through the secondary coil 5012 (current input into the rectifier circuit 61) and that through the secondary coil 5022 (current input into the rectifier circuit 62) become equal to each other. The value of a first rectified current I61 output from the rectifier circuit 61 and the value of a second rectified current I62 output from the rectifier circuit 62 become the same. As a result, the AC-DC converter 10F can output a stable DC current and DC voltage.

The AC-DC converter 10F can also reduce the undesired coupling between the isolation transformers 501 and 502. This can suppress the adverse influence on the DC output voltage and current caused by the undesired coupling between the isolation transformers 501 and 502. Hence, the AC-DC converter 10F can output an even stabler DC current and DC voltage.

### Eighth Embodiment

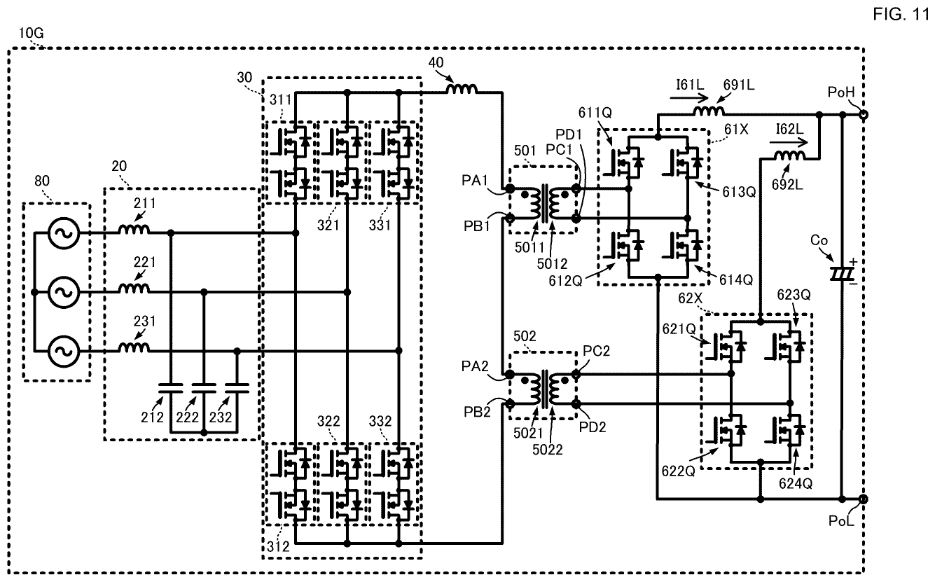

An AC-DC converter according to an eighth embodiment of the disclosure will be described below with reference to the drawing. FIG. 11 is a circuit diagram of the AC-DC converter according to the eighth embodiment.

As illustrated in FIG. 11, an AC-DC converter 10G of the eighth embodiment is different from the AC-DC converter 10F of the seventh embodiment in the configuration of a rectifier circuit connected to the secondary coil of an isolation transformer. The other portions of the AC-DC converter 10G are similar to those of the AC-DC converter 10F and an explanation thereof will thus be omitted.

The AC-DC converter 10G includes rectifier circuits 61X and 62X and DC inductors 691L and 692L.

The rectifier circuit 61X is a full-wave rectifier circuit (full-bridge rectifier circuit) using four switching devices 611Q, 612Q, 613Q, and 614Q. The rectifier circuit 61X is connected to the secondary coil 5012.

More specifically, the drain terminal of the switching device 611Q and the drain terminal of the switching device 613 are connected to each other; the source terminal of the switching device 611Q and the drain terminal of the switching device 612Q are connected to each other; the source terminal of the switching device 613Q and the drain terminal of the switching device 614Q are connected to each other; and the source terminal of the switching device 612Q and the source terminal of the switching device 614Q are connected to each other.

A node between the source terminal of the switching device 611Q and the drain terminal of the switching device 612Q is connected to the first terminal PC1 of the secondary coil 5012. A node between the source terminal of the switching device 613Q and the drain terminal of the switching device 614Q is connected to the second terminal PD1 of the secondary coil 5012.

A node between the drain terminal of the switching device 611Q and the drain terminal of the switching device 613Q is connected to one terminal of the series inductor 691L. The other terminal of the series inductor 691L is connected to the high-side output terminal PoH. A node between the source terminal of the switching device 612Q and the source terminal of the switching device 614Q is connected to the low-side output terminal PoH.

The rectifier circuit 62X is a full-wave rectifier circuit (full-bridge rectifier circuit) using four switching devices 621Q, 622Q, 623Q, and 624Q. The rectifier circuit 62D is connected to the secondary coil 5022.

More specifically, the drain terminal of the switching device 621Q and the drain terminal of the switching device 623 are connected to each other; the source terminal of the switching device 621Q and the drain terminal of the switching device 622Q are connected to each other; the source terminal of the switching device 623Q and the drain terminal of the switching device 624Q are connected to each other; and the source terminal of the switching device 622Q and the source terminal of the switching device 624Q are connected to each other.

A node between the source terminal of the switching device 621Q and the drain terminal of the switching device 622Q is connected to the first terminal PC2 of the secondary coil 5022. A node between the source terminal of the switching device 623Q and the drain terminal of the switching device 624Q is connected to the second terminal PD2 of the secondary coil 5022.

A node between the drain terminal of the switching device 621Q and the drain terminal of the switching device 623Q is connected to one terminal of the series inductor 692L. The other terminal of the series inductor 692L is connected to the high-side output terminal PoH. A node between the source terminal of the switching device 622Q and the source terminal of the switching device 624Q is connected to the low-side output terminal PoH.

The configuration of the DC inductor 691L and that of the DC inductor 692L are similar to each other. That is, the DC inductors 691L and 692L have similar inductance and similar inductance characteristics.

With the above-described configuration, the AC-DC converter 10G can achieve advantages similar to those of the AC-DC converter 10F. Additionally, the AC-DC converter 10G uses a full-wave rectifier circuit and a DC inductor for rectifying a current output from the secondary coil of an isolation transformer, thereby making it possible to more stably obtain a waveform closer to a DC waveform.

In the above-described configuration, as the DC inductors 691L and 692L, inductors configured as follows may be used.

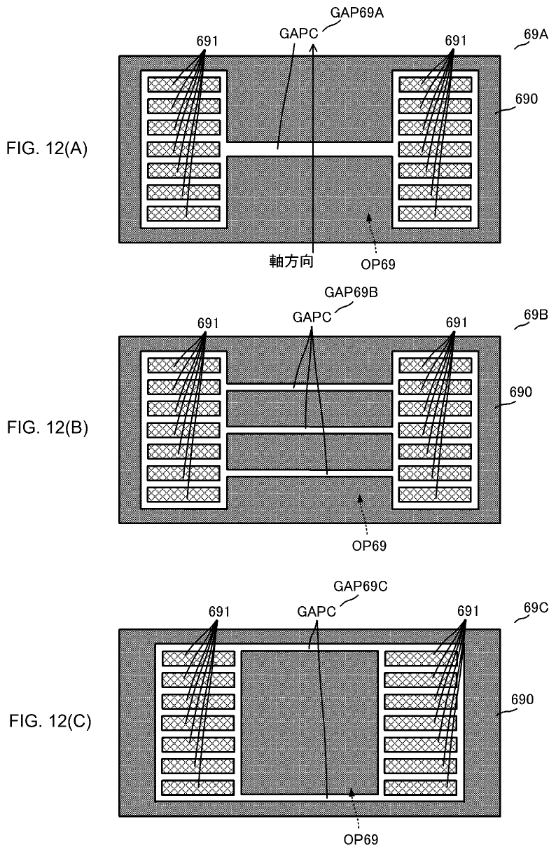

FIG. 12(A), FIG. 12(B), and FIG. 12(C) are sectional views illustrating the schematic configurations of DC inductors. In FIG. 12(A), FIG. 12(B), and FIG. 12(C), some elements, specifically emphasizing the magnetic core and gap structures. In some embodiments, the DC inductors include external connection terminals and wiring conductor patterns. Because of the structural difference between the DC inductors, the DC inductors in FIG. 12(A), FIG. 12(B), and FIG. 12(C) are appended with reference signs 69A, 69B, and 69C, respectively. If the DC inductor 69A in FIG. 12(A) is employed, for example, the DC inductors 61 and 62 are each constituted by the DC inductor 69A.

As illustrated in FIG. 12(A), the DC inductor 69A includes a magnetic core 690 and a winding conductor 691. The material of the magnetic core 690 may be Mn—Zn ferrite or a powder core. The winding conductor 691 is made of a metal having a high conductivity.

The winding conductor 691 is spirally formed and has a center opening OP69.

The magnetic core 690 contains the winding conductor 691 inside. The magnetic core 690 has a gap GAP69A. The gap GAP69A is a space inside the magnetic core 690 without a magnetic material.

The gap GAP69A is constituted by one gap GAPC.

The gap GAPC is formed in the center opening OP69 of the winding conductor 691. The gap GAPC is formed in a planar shape such that its planar surface is perpendicular to the axial direction of the winding conductor 691. In other words, the gap GAPC extends across the center opening OP69.

With the above-described configuration, the gap GAPC of the DC inductor 69A extends across the center opening OP69 having a high magnetic density. The DC inductor 69A can thus reduce the influence of manufacturing variations of the magnetic core on the inductance. That is, the difference in the inductance between two DC inductors which are manufactured in a similar manner can be reduced.

This can reduce the difference in the inductance between the two DC inductors connected to the two rectifier circuits in the vicinity of the secondary coils of the isolation transformers of the AC-DC converter. It is thus possible to suppress the occurrence of current ripple or voltage ripple, which is caused by the inductance difference, in a closed loop of the rectifier circuit connected to the secondary coil of the isolation transformer.

As illustrated in FIG. 12(B), the DC inductor 69B is different from the DC inductor 69A in FIG. 12(A) in that it includes a gap GAP69B constituted by three gaps GAPC.

The three gaps GAPC are formed in the center opening OP69 of the winding conductor 691. The three gaps GAPC are formed to have a distance therebetween in the axial direction.

With this configuration, the DC inductor 69B has the gaps GAP1 in the vicinity of the winding conductor 691 through which a current flows. The gaps GAPC extend across the center opening OP69 having a high magnetic density. The DC inductor 69B can thus achieve advantages similar to those of the DC inductor 69A.

As illustrated in FIG. 12(C), the DC inductor 69C is different from the DC inductor 69A in FIG. 12(A) in that it includes a gap GAP69C constituted by two gaps GAPC.

One gap GAPC is formed in the center opening OP69 of the winding conductor 691. One gap GAPC is formed in one opening of the winding conductor 691, while the other gap GAPC is formed in the other opening of the winding conductor 691.

With this configuration, the gaps GAPC of the DC inductor 69C extend across the center opening OP69 having a high magnetic density. The DC inductor 69C can thus achieve advantages similar to those of the DC inductor 69A.

The number of gaps GAPC formed in the above-described center opening OP69 may be four or more. In some embodiments, such as that shown in FIG. 12C, the gaps may be distributed across different legs of the magnetic core, or multiple gaps may be provided in different windows defined by the winding conductor.

The above-described magnetic core can be formed by sintering magnetic powder. As the magnetic core, an E-core magnetic core, for example, may be used.

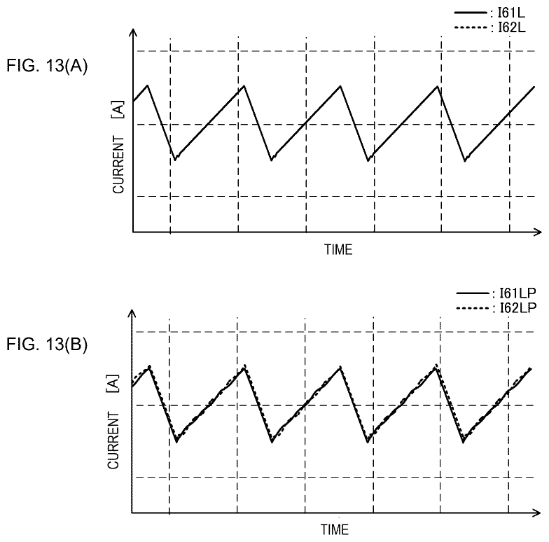

FIG. 13(A) is a waveform diagram illustrating an example of the waveform of an inductor current observed when the DC inductor in the application of the disclosure is used. FIG. 13(B) is a waveform diagram illustrating an example of the waveform of an inductor current in a comparative example.

The solid line in FIG. 13(A) indicates a current value I61L observed when the DC inductor in one of FIG. 12(A), FIG. 12(B), and FIG. 12(C) is used as the DC inductor 691L in the circuit shown in FIG. 11. The dotted line in FIG. 13(A) indicates a current value I62L observed when the DC inductor in one of FIG. 12(A), FIG. 12(B), and FIG. 12(C) is used as the DC inductor 692L in the circuit shown in FIG. 11.

The solid line in FIG. 13(B) indicates a current value I61LP observed when a DC inductor without a gap is used as the DC inductor 691L in the circuit shown in FIG. 11. The dotted line in FIG. 13(A) indicates a current value I62LP observed when a DC inductor without a gap is used as the DC inductor 692L in the circuit shown in FIG. 11.

The waveforms shown in FIG. 13(A) and FIG. 13(B) are obtained when the primary voltage of the isolation transformer is higher than 500 V, the frequency is about 70 kHz, and the output voltage of the AC-DC converter is 50 V.

As is seen from FIG. 13(A) and FIG. 13(B), the use of a DC inductor with the above-described gap can suppress low-frequency ripple in the current waveform. Voltage ripple of the DC inductor, ripple of the drain voltage of the rectifier circuit, and voltage ripple of the isolation transformer can also be reduced.

The occurrence of these ripples is dependent on the inductance difference between the DC inductors connected to the corresponding parallel-connected rectifier circuits in the vicinity of the secondary coils of the isolation transformers of the AC-DC converter. More specifically, as the inductance difference between the parallel-connected DC inductors is greater, the ripple (voltage ripple) also becomes greater.

However, the use of a DC inductor with the above-described gap can reduce the inductance difference and suppress the ripple, as discussed above.

The reduced ripple eliminates the need to increase the withstand voltage of the DC inductors 691L and 692L. The withstand voltage that is needed for the DC inductors 691L and 692L merely as the DC conversion function can be set. The AC-DC converter including DC inductors with the above-described gap can thus reduce the conduction loss of the DC inductors 691L and 692L.

The withstand voltage of the switching devices of the rectifier circuits 61 and 62 is not required to be increased, either. The withstand voltage that is needed for the switching devices merely as the rectifying function can be set. The AC-DC converter including DC inductors with the above-described gap can thus reduce the conduction loss of the switching devices of the rectifier circuits 61 and 62.

The withstand voltage of the isolation transformers is not required to be undesirably increased. The AC-DC converter including DC inductors with the above-described gap can also reduce the loss in the isolation transformers.

The configurations of the above-described embodiments may be partially combined with each other in a suitable manner. In this case, certain advantages can be obtained in accordance with a combination of the configurations of the embodiments.

<1> An AC-DC converter comprising:
a power conversion circuit that is connected to a three-phase AC power source and outputs a primary current;
an isolation transformer that includes first and second primary coils and first and second secondary coils and outputs first and second secondary currents by using the primary current as input, the first and second primary coils being connected in series with an output side of the power conversion circuit, the first secondary coil being coupled with the first primary coil, the second secondary coil being coupled with the second primary coil;
a first rectifier circuit that is connected to the first secondary coil and rectifies the first secondary current;
a second rectifier circuit that is connected to the second secondary coil and rectifies the second secondary current; and
a smoothing capacitor that is connected to an output terminal of the first rectifier circuit and an output terminal of the second rectifier circuit, wherein
the isolation transformer includes first and second isolation transformers, magnetic coupling between the first and second isolation transformers being suppressed,
the first and second primary coils are connected in series with each other,
the first isolation transformer includes the first primary coil and the first secondary coil,
the second isolation transformer includes the second primary coil and the second secondary coil,
the first and second rectifier circuits are connected in parallel with each other,
the first rectifier circuit includes a first switching device, and a first inductor is connected to the first switching device, and
the second rectifier circuit includes a second switching device, and a second inductor is connected to the second switching device.

<2> The AC-DC converter according to <1>, further comprising:
third and fourth isolation transformers, which are different from the first and second isolation transformers, magnetic coupling between the third and fourth isolation transformers being suppressed, the third isolation transformer including a third primary coil and a third secondary coil, the fourth isolation transformer including a fourth primary coil and a fourth secondary coil;
a third rectifier circuit connected to the third secondary coil; and
a fourth rectifier circuit connected to the fourth secondary coil.

<3> The AC-DC converter according to <2>, wherein:
the first and third rectifier circuits are connected in series with each other; and
the second and fourth rectifier circuits are connected in series with each other.

<4> The AC-DC converter according to <2> or <3>, wherein the first, second, third, and fourth rectifier circuits are each constituted by a current doubler rectifier circuit.

<5> The AC-DC converter according to one of <2> to <4>, wherein a first node between the first and third rectifier circuits and a second node between the second and fourth rectifier circuits are electrically connected to each other.

<6> The AC-DC converter according to one of <2> to <5>, wherein the first, second, third, and fourth primary coils are connected in series with each other.

<7> The AC-DC converter according to one of <2> to <5>, wherein:
the first and third primary coils are connected in series with each other;
the second and fourth primary coils are connected in series with each other; and
a series circuit of the first and third primary coils and a series circuit of the second and fourth primary coils are connected in parallel with each other.

<8> The AC-DC converter according to one of <2> to <7>, further comprising:
a circuit substrate having first and second surfaces, the first surface being one end of the circuit substrate in a thickness direction, the second surface being the other end of the circuit substrate in the thickness direction, wherein
the first, second, third, and fourth transformers, the first inductor of the first rectifier circuit, the second inductor of the second rectifier circuit, a third inductor of the third rectifier circuit, and a fourth inductor of the fourth rectifier circuit are mounted on the first surface, and
the first switching device of the first rectifier circuit, the second switching device of the second rectifier circuit, a third switching device of the third rectifier circuit, a fourth switching device of the fourth rectifier circuit are mounted on the second surface.

<9> The AC-DC converter according to <8>, wherein
when regions on the circuit substrate arranged side by side in a first direction are set to first and second regions, the first direction being a direction parallel with the first surface, and
when a region on the substrate located with the first region side by side in a second direction is set to a third region, the second direction being a direction perpendicular to the first direction, and when a region on the substrate located with the second region side by side in the second direction is set to a fourth region,
the first isolation transformer and the first inductor are mounted on the first surface in the first region,
the third isolation transformer and the third inductor are mounted on the first surface in the second region,
the second isolation transformer and the second inductor are mounted on the first surface in the third region,
the fourth isolation transformer and the fourth inductor are mounted on the first surface in the fourth region,
the first switching device is mounted on the second surface in the first region,
the third switching device is mounted on the second surface in the second region,
the second switching device is mounted on the second surface in the third region, and
the fourth switching device is mounted on the second surface in the fourth region.

<10> The AC-DC converter according to <9>, wherein:
the third isolation transformer, the third inductor, the first isolation transformer, and the first inductor are mounted on the first surface side by side in the first direction in order of the third isolation transformer, the third inductor, the first isolation transformer, and the first inductor; and
the fourth isolation transformer, the fourth inductor, the second isolation transformer, and the second inductor are mounted on the first surface side by side in the first direction in order of the fourth isolation transformer, the fourth inductor, the second isolation transformer, and the second inductor.

<11> The AC-DC converter according to <10>, further comprising:
at least one smoothing capacitor,
wherein, on the first surface of the substrate, the third isolation transformer, the third inductor, the first isolation transformer, the first inductor, and the at least one smoothing capacitor are arranged side by side in the first direction in order of the third isolation transformer, the third inductor, the first isolation transformer, the first inductor, and the at least one smoothing capacitor, or
wherein, on the first surface of the substrate, the fourth isolation transformer, the fourth inductor, the second isolation transformer, the second inductor, and the at least one smoothing capacitor are arranged side by side in the first direction in order of the fourth isolation transformer, the fourth inductor, the second isolation transformer, the second inductor, and the at least one smoothing capacitor.

<12> The AC-DC converter according to one of <1> to <11>, wherein the first and second rectifier circuits are each constituted by a full-bridge rectifier circuit.

<13> The AC-DC converter according to one of <1> to <12>, wherein:
the first and second inductors include a magnetic core; and
the magnetic core includes Mn—Zn ferrite or a powder core as a material and has a gap.

<14> The AC-DC converter according to <13>, wherein the gap is formed to extend across a center opening of the winding conductor.

<15> The AC-DC converter according to <14>, wherein a plurality of portions, which form the gap, extend across the center opening and are arranged in an axial direction of the winding conductor.

### REFERENCE SIGNS LIST

10, 10A, 10B, 10C, 10D, 10E, 10F, 10G: AC-DC converter
20: input filter circuit
30: power conversion circuit
40: resonant inductor
50: isolation transformer
51, 5011, 5021, 5031, 5041: primary coil
61, 61A, 61C, 61D, 61E, 61X, 62, 62A, 62C, 62D, 62E, 62X, 63E, 64E: rectifier circuit
61H, 61HE, 62H, 62HE, 63HE, 64HE: high-side rectifier circuit
61L, 61LE, 62L, 62LE, 63LE, 64LE: low-side rectifier circuit
90: circuit substrate
91: first surface
92: second surface
931, 932, 933, 934: side surface
211, 221, 231: inductor
212, 222, 232: capacitor
311, 312, 321, 322, 331, 332: switching circuit
501 to 508: isolation transformer
521, 522, 5012, 5022, 5032, 5042: secondary coil
611L, 611LH, 611LL, 613L, 613LH, 613LL, 621L, 621LH, 621LL, 622L, 623L, 623LH, 623LL: inductor
691L, 692L: DC inductor
612Q, 612QH, 612QL, 614Q, 614QH, 614QL, 622Q, 622QH, 622QL, 624Q, 624QH, 624QL: switching device
9911 to 9914, 9921 to 9924, 9931 to 9934, 9941 to 9944:
wiring pattern
Co: smoothing capacitor
Co1, Co2, Co3, Co4: capacitor
DIR1: first direction
DIR2: second direction
I61: first rectified current
I62: second rectified current
LD: load
ND611, ND6111, ND6112, ND612, ND6121, ND6122, ND61C, ND621, ND6211, ND6212, ND622, ND6221, ND6222, ND62C: node
PA, PA1, PA2, PA3, PA4, PC1, PC2, PC3, PC4: first terminal
PB, PB1, PB2, PB3, PB4, PD1, PD2, PD3, PD4: second terminal
PoH: high-side output terminal
PoL: low-side output terminal
RE61: first region
RE62: second region
RE63: third region
RE64: fourth region
Ri61L, Ri61H, Ri62L, Ri62H: current loop
V61A, V61H, V61L, V62A, V62H, V62L: voltage
ZD: load

1. An AC-DC converter comprising:
a power conversion circuit connected to a power source and configured to output a primary current;
an isolation transformer assembly that includes first and second primary coils and first and second secondary coils, the isolation transformer assembly configured to output first and second secondary currents based on the primary current, the first and second primary coils being connected in series with an output side of the power conversion circuit, the first secondary coil being coupled with the first primary coil, the second secondary coil being coupled with the second primary coil;
a first rectifier circuit connected to the first secondary coil configured to rectify the first secondary current;
a second rectifier circuit connected to the second secondary coil configured to rectify the second secondary current; and
a smoothing capacitor connected to an output terminal of the first rectifier circuit and an output terminal of the second rectifier circuit, wherein
the isolation transformer assembly includes first and second isolation transformers to suppress magnetic coupling between the first and second isolation transformers,
the first and second primary coils are connected in series with each other,
the first isolation transformer includes the first primary coil and the first secondary coil,
the second isolation transformer includes the second primary coil and the second secondary coil,
the first and second rectifier circuits are connected in parallel with each other,
the first rectifier circuit includes a first switch, and a first inductor is connected to the first switch, and
the second rectifier circuit includes a second switch, and a second inductor is connected to the second switch.

2. The AC-DC converter according to claim 1, further comprising:
third and fourth isolation transformers, different from the first and second isolation transformers, magnetic coupling between the third and fourth isolation transformers being suppressed, the third isolation transformer including a third primary coil and a third secondary coil, the fourth isolation transformer including a fourth primary coil and a fourth secondary coil;
a third rectifier circuit connected to the gapthird secondary coil; and
a fourth rectifier circuit connected to the fourth secondary coil.

3. The AC-DC converter according to claim 2, wherein:
the first and third rectifier circuits are connected in series with each other; and
the second and fourth rectifier circuits are connected in series with each other.

4. The AC-DC converter according to claim 2, wherein the first, second, third, and fourth rectifier circuits are each constituted by a current doubler rectifier circuit.

5. The AC-DC converter according to claim 2, wherein a first node between the first and third rectifier circuits and a second node between the second and fourth rectifier circuits are electrically connected to each other.

6. The AC-DC converter according to claim 2, wherein the first, second, third, and fourth primary coils are connected in series with each other.

7. The AC-DC converter according to claim 2, wherein:
the first and third primary coils are connected in series with each other;
the second and fourth primary coils are connected in series with each other; and
a series circuit of the first and third primary coils and a series circuit of the second and fourth primary coils are connected in parallel with each other.

8. The AC-DC converter according to claim 2, further comprising:
a circuit substrate having first and second surfaces, the first surface being one end of the circuit substrate in a thickness direction, the second surface being the other end of the circuit substrate in the thickness direction, wherein
the first, second, third, and fourth transformers, the first inductor of the first rectifier circuit, the second inductor of the second rectifier circuit, a third inductor of the third rectifier circuit, and a fourth inductor of the fourth rectifier circuit are mounted on the first surface, and
the first switching device of the first rectifier circuit, the second switch of the second rectifier circuit, a third switch of the third rectifier circuit, a fourth switch of the fourth rectifier circuit are mounted on the second surface.

9. The AC-DC converter according to claim 8, wherein
when regions on the circuit substrate arranged side by side in a first direction are set to first and second regions, the first direction being a direction parallel with the first surface, and
when a region on the substrate located with the first region side by side in a second direction is set to a third region, the second direction being a direction perpendicular to the first direction, and when a region on the substrate located with the second region side by side in the second direction is set to a fourth region,
the first isolation transformer and the first inductor are mounted on the first surface in the first region,
the third isolation transformer and the third inductor are mounted on the first surface in the second region,
the second isolation transformer and the second inductor are mounted on the first surface in the third region,
the fourth isolation transformer and the fourth inductor are mounted on the first surface in the fourth region,
the first switch is mounted on the second surface in the first region,
the third switch is mounted on the second surface in the second region,
the second switch is mounted on the second surface in the third region, and
the fourth switch is mounted on the second surface in the fourth region.

10. The AC-DC converter according to claim 9, wherein:
the third isolation transformer, the third inductor, the first isolation transformer, and the first inductor are mounted on the first surface side by side in the first direction in order of the third isolation transformer, the third inductor, the first isolation transformer, and the first inductor; and
the fourth isolation transformer, the fourth inductor, the second isolation transformer, and the second inductor are mounted on the first surface side by side in the first direction in order of the fourth isolation transformer, the fourth inductor, the second isolation transformer, and the second inductor.

11. The AC-DC converter according to claim 10, further comprising:
at least one smoothing capacitor,
wherein, on the first surface of the substrate, the third isolation transformer, the third inductor, the first isolation transformer, the first inductor, and the at least one smoothing capacitor are arranged side by side in the first direction in order of the third isolation transformer, the third inductor, the first isolation transformer, the first inductor, and the at least one smoothing capacitor, or
wherein, on the first surface of the substrate, the fourth isolation transformer, the fourth inductor, the second isolation transformer, the second inductor, and the at least one smoothing capacitor are arranged side by side in the first direction in order of the fourth isolation transformer, the fourth inductor, the second isolation transformer, the second inductor, and the at least one smoothing capacitor.

12. The AC-DC converter according to claim 1, wherein the first and second rectifier circuits are each constituted by a full-bridge rectifier circuit.

13. The AC-DC converter according to claim 1, wherein:
the first and second inductors include a magnetic core; and
the magnetic core includes Mn-Zn ferrite or a powder core as a material and has a gap.

14. The AC-DC converter according to claim 13, wherein the gap is formed to extend across a center opening of the winding conductor.

15. The AC-DC converter according to claim 14, wherein a plurality of portions, which form the gap, extend across the center opening and are arranged in an axial direction of the winding conductor.

16. The AC-DC converter according to claim 1, wherein the first and second isolation transformers each include an independent magnetic core and the magnetic core of the first isolation transformer is disposed separately from the magnetic core of the second isolation transformer.

17. An AC-DC converter comprising:
a circuit substrate having a first surface and a second surface opposite the first surface;
power conversion circuitry configured to generate a primary current;
a plurality of isolation transformers mounted on the first surface of the circuit substrate, each isolation transformer having a primary coil and a secondary coil, wherein the primary coils are connected in series; and
a plurality of rectifier circuits connected in parallel, each rectifier circuit corresponding to one of the plurality of isolation transformers, each rectifier circuit including an inductor and a switch,
wherein the inductors of the plurality of rectifier circuits are mounted on the first surface and the switches of the plurality of rectifier circuits are mounted on the second surface.

18. The AC-DC converter according to claim 17, wherein:
the circuit substrate includes first and second regions arranged side by side in a first direction, a third region adjacent to the first region in a second direction perpendicular to the first direction, and a fourth region adjacent to the second region in the second direction,
a first isolation transformer and a first inductor are mounted on the first surface in the first region,
a second isolation transformer and a second inductor are mounted on the first surface in the second region,
a third isolation transformer and a third inductor are mounted on the first surface in the third region,
a fourth isolation transformer and a fourth inductor are mounted on the first surface in the fourth region,
a first switch is mounted on the second surface in the first region,
a second switch is mounted on the second surface in the second region,
a third switch is mounted on the second surface in the third region, and
a fourth switch is mounted on the second surface in the fourth region.

19. A power conversion assembly comprising:
transformer circuitry including a first transformer and a second transformer, the first and second transformers having primary windings connected in series;
rectifier circuitry including a first current doubler rectifier connected to the first transformer and a second current doubler rectifier connected to the second transformer, the first and second current doubler rectifiers being connected in parallel to a common output; and
a plurality of DC inductors disposed within the rectifier circuitry, each DC inductor including
a winding conductor defining a center opening, and
a magnetic core containing the winding conductor, having at least one gap extending across a center opening of a winding conductor wherein the magnetic core includes at least one gap located within the center opening and extending across a cross-section of the magnetic core perpendicular to an axial direction of the winding conductor.

20. The power conversion assembly according to claim 19, wherein the at least one gap includes a plurality of gaps arranged at different positions along the axial direction of the winding conductor within the center opening.
